(19) United States
(12) Patent Application Publication
(10) Pub. No.: US 2026/0327395 A1
(43) Pub. Date: Oct. 22, 2026

(54) METHOD FOR REMOVAL OF ADDITIVES FROM A POLYMERIC MATERIAL

(71) Applicant: BASF SE, Ludwigshafen am Rhein (DE)

(72) Inventors: Sina WITZEL, Ludwigshafen am Rhein (DE); Hannah Stephanie MANGOLD, Ludwigshafen am Rhein (DE); Indre THIEL, Ludwigshafen am Rhein (DE); Hector Alonso FERNANDEZ, Arteixo (ES); Felix Poza PENA, Arteixo (ES)

(21) Appl. No.: 19/486,561

(22) PCT Filed: Jun. 18, 2024
(86) PCT No.: PCT/EP2024/066928

§ 371 Date: Nov. 21, 2025

(30) Foreign Application Priority Data
Jun. 19, 2023 (EP) 23180065.7

(51) Int. Cl. C08J 11/08

(52) U.S. Cl. CPC C08J 11/08; C08J 2367/02

(57) ABSTRACT

Disclosed herein are a method for removal of additives from a polymeric material, a polyalkylene terephthalate based polymer obtained from the method, a method of using the polyalkylene terephthalate based polymer for textile applications, fiber applications, packaging applications, plastic applications, automotive applications, or electronic applications a method for preparing a product including an electronic part from the polyalkylene terephthalate based polymer, a method including converting the polyalkylene terephthalate based polymer obtained by the method to obtain a polymer product, and a method including converting a residue obtained by the method and/or converting an elastic fiber residue obtained by the method to obtain one or more monomer, polymer or polymer product.

In a first aspect, the invention is directed to a method for removal of additives from a polymeric material, which contains a polyalkylene terephthalate based polymer and an additive, the method comprising: (a) providing the polymeric material and providing a first solvent system and/or a second solvent system; (b) contacting the polymeric material with a first solvent system at a temperature T₁, which is <170° C., thereby obtaining a first solvent system, which is enriched in dissolved additive and a residue of the polymeric material, which is depleted of said additive and comprises the polyalkylene terephthalate based polymer, wherein the first solvent system comprises one or more solvents, wherein (s1.1) the solvent system has Hansen solubility parameters with respect to energy from dispersion forces between molecules (δDₛₛ), energy from dipolar intermolecular force between molecules (δPₛₛ) and energy from hydrogen bonds between molecules (δHₛₛ), which fulfill equitation 1 (11)²≥4 (δDₛₛ-17.5)²+(δPₛₛ-7.5)²+(δHₛₛ7.5)² [equitation 1]; (s1.2) each solvent of the solvent system has a boiling point at 1013 hPa of at least 150° C.; and/or (c) contacting the polymeric material provided in (a) or the residue of the polymeric material obtained in (b) with a second solvent system at a temperature T₂, wherein T₂>T₁ and T₂ is at least 1K, preferably at least 7K, below the boiling temperature of the solvent in the second solvent system, which has the lowest boiling point, thereby obtaining a second solvent system, which is enriched in dissolved polyalkylene terephthalate based polymer and optionally enriched in additive compared to the second solvent system provided in (a); and re-obtaining polyalkylene terephthalate based polymer from the second solvent system obtained; wherein the second solvent system comprises one or more solvents and (s2.1) has Hansen solubility parameters with respect to energy from dispersion forces between molecules (δDₛₛ), energy from dipolar intermolecular force between molecules (δPₛₛ) and energy from hydrogen bonds between molecules (δHₛₛ), which fulfill equitation 2 (8.8)²≥4 (δDₛₛ-20)²+(δPₛₛ-11.8)²+(δHₛₛ-4.5)² [equitation 2], (s2.2) each solvent of the solvent system has a boiling point at 1013 hPa of at least 160° C.; and (s2.3) solvents having a functional group selected from the group consisting of hydroxyl (OH), amino (NH₂), carboxyl (COOH), and thiol (SH) are excluded.

A second aspect is related to a polyalkylene terephthalate based polymer obtained or obtainable from the method of the first aspect. A third aspect relates to the use of the polyalkylene terephthalate based polymer of the second aspect for textile applications, fiber applications, packaging applications, plastic applications, automotive applications, electronic applications, whereas a fourth aspect is directed to a method for preparing a product comprising (I) providing polyalkylene terephthalate based polymer of the second aspect; (II) preparing a textile, a fiber, a packaging, a plastic, an automotive part, an electronic part from the polyalkylene terephthalate based polymer provided in (I). In a fifth aspect, the invention relates to a method comprising the further step of converting the re-obtained polyalkylene terephthalate based polymer obtained by the method according to the first aspect to obtain a polymer product. A sixth aspect is related to a method comprising the further step of converting a residue obtainable by or obtained by the method of the first aspect, and/or of converting an elastic fiber residue obtainable by or obtained by the method of the first aspect to obtain one or more monomer, polymer or polymer product.

The demand for polymeric materials has drastically increased over the last decades. However, the poor biodegradability has led to large amounts of plastic waste which is in Europe usually incinerated thereby losing valuable materials and generating huge CO₂ emissions. Even worse is landfill due to the poor biodegradability. Polymeric materials have been used extensively in the packaging sector, for example, in beverage packaging or food packaging. The vast majority of food and beverage today is packaged within plastic bottles and containers, made from, for example, polymeric materials comprising polyethylene terephthalate (PET). PET is also a main component of clothing nowadays. As these materials typically have poor biodegradability and are also still valuable products, it is desirable for these plastics to be recovered and recycled.

Although recycling processes have been adopted to convert the waste materials into new production materials, there are still many problems associated with recycling and recovery of polymeric materials. Waste packaging often includes a mixture of different polymeric materials containing also, for example, additives. The same applies also for textiles, which also comprise a high amount of additive supplemented polymeric materials.

So far, no processes are known for removing additives from a polymeric material, which contains polyethylene terephthalate (PET), wherein especially the PET is not degradated by the removal. Further drawbacks are the necessity to use toxic solvents and/or the need to use large quantities of solvents.

The technical problem underlying the present invention was thus the provision of an economically process for recovery of a polyalkylene terephthalate based polymer which overcomes these disadvantages, and which especially enables on one hand a precise removal of additives and/or further polymers and on the other hand the recovery of non-degradated polyalkylene terephthalate based polymer, while using comparatively small quantities of solvent.

A first aspect of the invention is thus directed to a method for removal of additives from a polymeric material, which contains a polyalkylene terephthalate based polymer and an additive, the method comprising:
(a) providing the polymeric material and providing a first solvent system and/or a second solvent system;
(b) contacting the polymeric material with a first solvent system at a temperature T₁, which is <170° C., thereby obtaining a first solvent system, which is enriched in dissolved additive and a residue of the polymeric material, which is depleted of said additive and comprises the polyalkylene terephthalate based polymer,
wherein the first solvent system comprises one or more solvents, wherein
(s1.1) the solvent system has Hansen solubility parameters with respect to
   energy from dispersion forces between molecules (δDₛₛ),
   energy from dipolar intermolecular force between molecules (δPₛₛ) and
   energy from hydrogen bonds between molecules (δHₛₛ),
which fulfill equitation 1

(11)²≥4(δDₛₛ-17.5)²+(δPₛₛ-7.5)²+(δHₛₛ-7.5)² [equitation 1]
(s1.2) each solvent of the solvent system has a boiling point at 1013 hPa of at least 150° C.;
and/or
(c) contacting the polymeric material provided in (a) or the residue of the polymeric material obtained in (b) with a second solvent system at a temperature T₂, wherein T₂>T₁ and T₂ is at least 1K, preferably at least 7K, below the boiling temperature of the solvent in the second solvent system, which has the lowest boiling point, thereby obtaining a second solvent system, which is enriched in dissolved PET and optionally enriched in additive compared to the second solvent system provided in (a); and re-obtaining polyalkylene terephthalate based polymer from the second solvent system obtained;
wherein the second solvent system comprises one or more solvents and
(s2.1) has Hansen solubility parameters with respect to
   energy from dispersion forces between molecules (δDₛₛ),
   energy from dipolar intermolecular force between molecules (δPₛₛ) and
   energy from hydrogen bonds between molecules (δHₛₛ),
which fulfill equitation 2

(8.8)²≥4(0Dₛₛ-20)²+(δPₛₛ-11.8)²+(δHₛₛ-4.5)² [equitation 2]
(s2.2) each solvent of the solvent system has a boiling point at 1013 hPa of at least 160° C.; and
(s2.3) solvents having a functional group selected from the group consisting of hydroxyl (OH), amino (NH₂), carboxyl (COOH), and thiol (SH) are excluded.

It was surprisingly found that all solvent systems having Hansen parameters fulfilling equitation 1 (s1.1) and fulfilling requirements (s1.2) and optionally (s1.3) are able to remove additives efficiently from the polyalkylene terephthalate based polymer in step (b) and do not have a negative impact on the re-obtained polyalkylene terephthalate based polymer, i.e. at least the number average molecular weight Mn of the re-obtained polyalkylene terephthalate based polymer is not detrimentally influenced—the Mn of the re-obtained polyalkylene terephthalate based polymer is always greater or at least equal to the Mn of the polyalkylene terephthalate based polymer comprised in the material initially provided. The same applies for the dissolution of step (c) using a solvent system fulfilling (s2.1), (s2.2) and (s2.3), i.e. this also results in a non-degradated re-obtained polyalkylene terephthalate based polymer. This offers the great advantage that the re-obtained polyalkylene terephthalate based polymer can directly be re-used. Obtaining non-degradated polyalkylene terephthalate based polymer enables further processing of the polyalkylene terephthalate based polymer in a, preferably closed, loop recycling process. Preferably, the colored polymeric material, which preferably comes from textiles, fibers and/or packaging is thus recycled or recyclable into the same. Naturally, the re-obtained can also be put to any further use without being restricted in this regard.

Regarding the first solvent system, any solvent system for which 4 (δDₛₛ-17.5)²+(OP ss-7.5)²+ (δHₛₛ-7.5)² is equal or smaller than (11)² (i.e. 121) is suited to dissolve the additive while leaving the polyalkylene terephthalate based polymer almost completely undissolved. Regarding the second solvent system, any solvent system for which 4 (δDₛₛ-20)²+(δPₛₛ-11.8)²+(δHₛₛ-4.5)² is larger than (8.8)² (i.e. 77.44) is not suited to dissolve the additive and/or the polyalkylene terephthalate based polymer, and any solvent system for which 4 (δDₛₛ-20)²+(δPₛₛ-11.8)²+(δHₛₛ4.5)² is equal to or smaller than (8.8)² (i.e. 77.44) is suitable for dissolving the additive and the polyalkylene terephthalate based polymer. In case of two or more solvents being part of the first or second solvent system, i.e. n solvents with n being an integer with n>2 and i=1 . . . n, the Hansen solubility parameters of the resulting mixture with respect to each of δDₛₛ, δHₛₛ and δPₛₛ are calculated, knowing the percentage part of each solvent in the solvent system, as the weighted arithmetic mean from δDₛᵢ, δHₛᵢ and δPₛᵢ of each of the n solvents S(i). The Hansen parameters are to be found in BIOVIA COSMOquick 2022.

Considering the three-dimensional form given by, for example, equitation 2 in the three-dimensional Hansen space, a sphere is formed which has its center at δD_{c}=20, δP_{c}=11.8 and δH_{c}=4.5 and a radius r of 8.8. The doubling of the dispersion parameter value is required, according to Charles Hansen, for achieving a spherical form. A Hansen sphere, since there are no negative values possible for δH, can also be considered as a dome, i.e. a half-sphere. The same principles apply for the three-dimensional form given by equitation 1 in the three-dimensional Hansen space.

Regarding step (b), “enriched in dissolved additive” means that at least 50 weight-%, preferably at least 60 weight-%, more preferably at least 70 weight-%, more preferably at least 80 weight-%, more preferably at least 90 weight-%, more preferably at least 95 weight-%, of the additive comprised in the material provided in (a), preferably of the additive comprised in the polyalkylene terephthalate based polymer contained therein, are dissolved in the solvent system, based on the total additive and the total polyalkylene terephthalate based polymer respectively comprised in the material provided in (a) being 100 weight-%. Regarding step (c), “enriched in dissolved polyalkylene terephthalate based polymer and optionally in additive” respectively means that at least 50 weight-%, preferably at least 60 weight-%, more preferably at least 70 weight-%, more preferably at least 80 weight-%, more preferably at least 90 weight-%, more preferably at least 95 weight-%, of the polyalkylene terephthalate based polymer and the additive comprised in the material provided in (a) are dissolved in the solvent system, based on the total additive and the total polyalkylene terephthalate based polymer respectively comprised in the material provided in (a) being 100 weight-% . . . . Generally, “enriched in a component” with respect to a solvent system means that at least 50 weight-%, preferably at least 60 weight-%, more preferably at least 70 weight-%, more preferably at least 80 weight-%, more preferably at least 90 weight-%, more preferably at least 95 weight-%, of the respective component are no longer present in the material, with which the solvent system has been contacted but are rather dissolved in the solvent system, each in relation to the content of the respective component in the material before contacting with the solvent system being 100 weight-%. The same considerations apply also to a residue of a polymeric material, which is depleted of additive and comprises polyalkylene terephthalate based polymer, i.e. depleted with respect to the residue of a polymeric material means that at least 50 weight-%, preferably at least 60 weight-%, more preferably at least 70 weight-%, more preferably at least 80 weight-%, more preferably at least 90 weight-%, more preferably at least 95 weight-%, of the additive initially contained in the polymeric material provided in (a), preferably of the colorant comprised in the polyalkylene terephthalate based polymer contained therein, are removed therefrom, each in relation to the content of the additive in the polymeric material before removal being 100 weight-%.

In some embodiments of the method, in the first solvent system used for step (b)
(s1.3) solvents having a functional group selected from the group consisting of hydroxyl (OH), amino (NH₂), carboxyl (COOH), and thiol (SH) are excluded.

In some embodiments of the method, in the first solvent system used for step (b)
(s1.3a) solvents having a functional group selected from the group consisting of hydroxyl (OH), amino (NH₂), secondary amine (—NH—), carboxyl (COOH), and thiol (SH) are excluded;
and/or, preferably and,
in the second solvent system used for step (i)
(s2.3a) solvents having a functional group selected from the group consisting of hydroxyl (OH), amino (NH₂), secondary amine (—NH—), carboxyl (COOH), and thiol (SH) are excluded.

### Temperatures

In some embodiments of the method, contacting in (b) is done at a temperature T₁, which is in the range of from 10 to <170° C., wherein T₁ is preferably in the range of from 100 to <170° C., more preferably in the range of from 110 to <170° C., more preferably in the range of from 110 to 165° C., more preferably in the range of from 120 to 150° C.

In some embodiments of the method, contacting in (c) is done at a temperature T₂, which is in the range of from 160° C. to the temperature T, which is at least 1K, preferably at least 7K, below the boiling temperature of the solvent in the solvent system, which has the lowest boiling point.

### Additives

In some embodiments of the method, the additive is selected from the group consisting of softener, water repellent, flame retardant, UV filter, plasticizer, and mixtures of two or more thereof.

A softener is preferably selected from the group consisting of silicone based softener, fatty alcohol, fatty acid, fatty amino acid, fatty acid derivate, fatty amino acid derivate, polyethylene, alkyl imidazolinium salt, bisquaternary ammonium salt and mixtures of two or more thereof, wherein “fatty” refers to an alkyl chain having in the range of from 8 to 22 C atoms; more preferably selected from the group consisting of polydiorganosiloxane (preferably polydimethylsiloxane and/or derivative of polydimethylsiloxane), fatty alcohol, condensation product of fatty amino acid with ethylene oxide, ethoxylated fatty acid, ethoxylated fatty alcohol, paraffin, oxidized polyethylene wax, optionally in combination with quaternary ammonium compounds, wherein the quaternary ammonium compound is preferably selected from the group of N⁺R¹R²R³R⁴, wherein R¹ and R² are independently selected from C₁ to C₃ alkyl and, optionally substituted with a hydroxyl group, and R³ and R⁴ are independently selected from C8 to C22 alkyl and C₂ to C₄ alkyl-C(═O)—O—C8 to C22 alkyl; wherein the ammonium compound is more preferably selected from dimethyl (dihydrogenated tallow) ammonium, dimethyl distearyl ammonium and mixtures of these two, wherein the positive charge of the quaternary ammonium compound is preferably compensated by one or more anions, preferably selected from chloride, methyl sulfate and mixture of these two anions.

A water repellent is preferably selected from the group consisting of siloxane (preferably unsaturated (e.g. vinyl-terminated) polydialkylsiloxane, hexamethyldisiloxane or a mixture of two or more thereof), silane (preferably hexatrimethoxysilane), paraffin (preferably in dispersion with aluminum salts, more referably stearic acid with aluminum or zirconium salts), fat modified melamine (preferably stearic acid-melamine derivate), silicone, tin octoate, fluorocarbon (preferably selected from perfluorohexanoic acid (PFHA), perfluorooctanoic acid (PFOA), perfluorooctane sulfonate (PFOS), and mixtures of two or more thereof), acrylic polymers containing perfluoroalkyl chains, alkylphenol ethoxylate (APEO), and mixtures of two or more thereof. Regarding the acrylic polymers containing perfluoroalkyl chains, the length of the perfluorinated alkyl side chains is in the range of from 8 to 10 carbon atoms. The small spacer group, mostly ethylene, can be modified to improve emulsification and solubility of the polymer. Comonomers such as stearyl- or laurylmethacrylate, butylacrylate, methylol- or epoxy-functional acrylates and block copolymers from α, ω dihydroxydimethylpolysiloxane.

A flame retardant is preferably selected from the group consisting of halogenated flame retardant (preferably hexabromocyclododecane, decabromodiphenyl ether, bis(hexachlorocyclopentadieno) cyclo-octane, trisdibromopropylphosphate, decabromodiphenyl oxide (DBDPO) and mixtures of two or more thereof), non-halogenated flame retardant, phosphor-containing flame retardant, phosphor-free flame retardant (preferably selected from the group consisting of tetraethoxysilane (TEOS), (3-aminopropyl)triethoxysilane (APTES), 3-glycidyloxypropyl trimethoxysilane (GPTMS) and mixtures of two or more thereof), compound without halogenates and phormol, compound with halogenates or phormol, metal hydroxide, and mixtures of two or more thereof; more preferably from the group consisting of oligomeric reaction products with urea of hydroxymethyl phosphonium chloride, aluminiumhydroxid, calcium carbonate, and mixtures of two or more thereof.

A UV filter is preferably selected from the group of hydroxyphenone derivative (preferably from the group of hydroxyphenyl triazines), benzotriazole (preferably 2-(2H-benzotriazol-2-yl)-4,6-bis(1-methyl-1-phenylethyl)), oxanilide, hydroxyphenyl benzotriazole, derivative of Hindered Amine Light UV stabilizers (HALS derivatives), benzothiazinone, salicyclic acid ester, cinnamic acid ester, resorcinol monobenzoate, hydroxybenzoic acid ester, cyanoacrylate, benzophenone, and mixtures of two or more thereof.

A plastiziser is preferably selected from the group consisting of phthalic acid ester, adipic acid ester, terephthalic acid diester, trialkyl trimellitate, 1,2-cyclohexandicarboxylic diester, 1,3-cyclohexandicarboxylic diester, 1,4-cyclohexandicarboxylic diester, and mixtures of two or more thereof.

In some embodiments of the method, colorants and optical brighteners are excluded as additive.

In some embodiments of the method, the residue of the polymeric material, which is depleted of said additive and comprises the polyalkylene terephthalate based polymer obtained in (b) and/or the re-obtained polyalkylene terephthalate based polymer of (c) consist of at least 95 weight-% polyalkylene terephthalate based polymer, preferably in the range of from 97 to 98 weight-% of the residue of the polymeric material, which is depleted of said additive and comprises the polyalkylene terephthalate based polymer obtained in (b) and/or the re-obtained polyalkylene terephthalate based polymer of (c) consist of polyalkylene terephthalate based polymer.

### Solvent Systems

In some embodiments of the method, at least 90 weight-%, preferably at least 95 weight-%, more preferably at least 98 weight-%, more preferably in the range of from 99 to 100 weight-%, of the first solvent system and/or second solvent system, each solvent system consist of one or more solvent(s), based on the total weight of the solvent system being 100 weight-%.

In some embodiments of the method, at least 90 weight-%, preferably at least 95 weight-%, more preferably at least 98 weight-%, more preferably in the range of from 99 to 100 weight-%, of the first solvent system and/or second solvent system consist of one solvent, which fulfills equation 1, based on the total weight of the solvent system being 100 weight-%.

In some embodiments of the method, the one or more solvent(s) of the first solvent system and/or second solvent system is/are selected from the group consisting of N,N-dimethylbenzamide, N,N-dimethylphenylacetamide, 1,4-benzoquinone, acetophenone, dimethyl terephthalate, 1,3,5-trimethoxybenzene, 2-phenylacetophenone, N-methylcaprolactam, methylbenzoate, methyl-4-methoxybenzoate, butylene carbonate, propylene-glycol-dibenzoate, N-ethylpyrrolidone, benzophenone, di-benzyl malonate, N-ethyl-caprolactam, methyl 2-(5-oxotetrahydrofuran-3-yl)acetate (FAME), propiophenone, N-methoxypropyl-pyrrolidone, 1,4-cyclohexanedione, cyclohexane-carbonate, N-methoxyethyl-pyrrolidone, N, N-diethylphenylacetamide, phenyl acetate, 1-(2-hydroxyethyl) pyrrolidin-2-one acetate (HEPAc), N,N-diethylbenzamide, isopropyl-benzoate, cyclohexyl phenyl ketone, phenylacetic acid ethylester, phenylacetat, N-methyl-morpholine, benzyl-propionate, benzylacetate, Neopentyl-glycol-dibenzoate, retrahydrofurfuryl acetate, N-methyl-imidazole, benzyl butyrate, 2-pyrrolidone, 2-phenoxyethanol propionate, 2-phenoxyethyl isobutyrate, N, N-dipropylbenzamide, N, N-dimethylacetamide, N,N-diethylacetamide, dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), delta-valerolactone, gamma butyrolactone, dimethylsulfoxide, methyl 5-(dimethylamino)-2-methyl-5-oxopentanoate (Rhodiasolv Polarclean), caprolactam, phen etyl acetate, methyl phenylacetate, benzyl benzoate, N,N-dimethyllactamide (Agnique AMD 3L), and dimethyl sulfoxide (DMSO).

In some embodiments of the method, the one or more solvent(s) of the first solvent system and/or second solvent system is/are selected from the group consisting of dihydrolevoglucosenon (Cyrene), propylenecarbonate, caprolactone, dimethylisosorbide, N-butylpyrrolidone, tbutylpyrrolidone, methyl-1-methyl-5-oxopyrrolidine-3-carboxylate (MMOC), gamma-valerolactone (GVL), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, propyl benzoate, and dimethyl sulfoxide (DMSO).

In some embodiments of the method, the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, propyl benzoate, and GVL.

In some embodiments of the method, the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, and propyl benzoate.

In some embodiments of the method, the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv®Polarclean), phenethyl acetate, and GVL.

In some embodiments of the method, the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv®Polarclean), and phenethyl acetate.

In some embodiments of the process, the one or more solvent(s) of the first solvent system and/or second solvent system is/are selected from the group consisting of gamma valerolactone (GVL), N-butylpyrrolidone (NBP), propylenecarbonate, acetophenone, dimethyl sulfoxide (DMSO), dihydrolevoglucosenon (Cyrene) and mixtures of two or more thereof. In some embodiments of the process, the one or more solvent(s) of the first solvent system and/or second solvent system is/are selected from the group consisting of gamma valerolactone (GVL), N-butylpyrrolidone (NBP), propylenecarbonate, acetophenone, dimethyl sulfoxide (DMSO) and mixtures of two or more thereof. In some embodiments of the process, the one or more solvent(s) of the first solvent system and/or second solvent system is/are selected from the group consisting of gamma valerolactone (GVL), N-butylpyrrolidone (NBP), propylenecarbonate, acetophenone and mixtures of two or more thereof. In some embodiments of the process, the one or more solvent(s) of the first solvent system and/or second solvent system is/are selected from the group consisting of gamma valerolactone (GVL), N-butylpyrrolidone (NBP), acetophenone and mixtures of two or more thereof. In some embodiments of the process, the one or more solvent(s) of the first solvent system and/or second solvent system is/are selected from the group consisting of gamma valerolactone (GVL), N-butylpyrrolidone (NBP) and mixtures of GVL and NBP.

In some embodiments of the process, the one or more solvent(s) of the first solvent system and/or second solvent system is/are selected from the group consisting of N-butylpyrrolidone (NBP), propylenecarbonate, acetophenone, dimethyl sulfoxide (DMSO), dihydrolevoglucosenon (Cyrene) and mixtures of two or more thereof. In some embodiments of the process, the one or more solvent(s) of the first solvent system and/or second solvent system is/are selected from the group consisting of N-butylpyrrolidone (NBP), propylenecarbonate, acetophenone, dimethyl sulfoxide (DMSO) and mixtures of two or more thereof. In some embodiments of the process, the one or more solvent(s) of the first solvent system and/or second solvent system is/are selected from the group consisting of N-butylpyrrolidone (NBP), propylenecarbonate, acetophenone and mixtures of two or more thereof. In some embodiments of the process, the one or more solvent(s) of the first solvent system and/or second solvent system is/are selected from the group consisting of N-butylpyrrolidone (NBP), acetophenone and mixtures of N-butylpyrrolidone (NBP) and acetophenone.

In some embodiments of the process, the one or more solvent(s) of the first solvent system and/or second solvent system comprise at least N-butylpyrrolidone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and/or second solvent system are N-butylpyrrolidone, based on a total weight of the one or more solvent(s) of the first solvent system and second solvent system, respectively, being 100 weight-%, more preferably the one solvent of the first solvent system and/or second solvent system is N-butylpyrrolidone. In some embodiments, contacting in (b) is done at a temperature T₁, which may be in the range of from 10 to <170° C., wherein T₁ preferably may be in the range of from 140 to 160° C., more preferably in the range of from 150 to 160° C., or contacting in (b) is done at a temperature T₁, which may be in the range of from 101 to 81 K below the boiling point of the N-butylpyrrolidone, preferably in the range of from 91 to 81 K below the boiling point of the N-butylpyrrolidone. Further, In some embodiments, contacting in (c) is done at a temperature T₂, which may be in the range of from 160° C. to the temperature T, which is at least 7K below the boiling temperature of the N-butylpyrrolidone, preferably at a temperature T₂ in the range of from 180 to 200° C., more preferably in the range of from 185 to 195° C. or contacting in (c) is done at a temperature T₂, which may be in the range of from 61 to 41 K below the boiling point of the N-butylpyrrolidone, preferably in the range of from 56 to 46 K below the boiling point of the N-butylpyrrolidone. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of N-butylpyrrolidone at the temperature T at which the process is run. The skilled person can determine and/or adjust said autogenous pressure according to the steam pressure curve of N-butylpyrrolidone at a certain temperature T. Steam pressure curves of N-butylpyrrolidone are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) of the first solvent system and/or second solvent system comprise at least propylenecarbonate, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and/or second solvent system are propylenecarbonate, based on a total weight of the one or more solvent(s) of the first solvent system and second solvent system, respectively, being 100 weight-%, more preferably the one solvent of the first solvent system and/or second solvent system is propylenecarbonate. In some embodiments, contacting in (b) is done at a temperature T₁, which may be in the range of from 10 to <170° C., wherein T₁ preferably may be in the range of from 140 to 160° C., more preferably in the range of from 150 to 160° C., or contacting in (b) is done at a temperature T₁, which may be in the range of from 102 to 82 K below the boiling point of the of the propylenecarbonate, preferably in the range of from 92 to 82 K below the boiling point of the of the propylenecarbonate. Further, In some embodiments, contacting in (c) is done at a temperature T₂, which may be in the range of from 160° C. to the temperature T, which is at least 7K below the boiling temperature of the propylenecarbonate, preferably at a temperature T₂ in the range of from 185 to 205° C., more preferably in the range of from 190 to 200° C., or contacting in (c) is done at a temperature T₂, which may be in the range of from 57 to 37 K below the boiling point of the of the propylenecarbonate, preferably in the range of from 52 to 42 K below the boiling point of the of the propylenecarbonate. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of propylenecarbonate at the temperature T at which the process is run. The skilled person can determine and/or adjust said autogenous pressure according to the steam pressure curve of propylenecarbonate at a certain temperature T. Steam pressure curves of propylenecarbonate are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) of the first solvent system and/or second solvent system comprise at least acetophenone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and/or second solvent system are acetophenone, based on a total weight of the one or more solvent(s) of the first solvent system and second solvent system, respectively, being 100 weight-%, more preferably the one solvent is acetophenone. In some embodiments, contacting in (b) is done at a temperature T₁, which may be in the range of from 10 to <170° C., wherein T₁ preferably may be in the range of from 140 to 160° C., more preferably in the range of from 150 to 160° C., or contacting in (b) is done at a temperature T₁, which may be in the range of from 62 to 42 K below the boiling point of the of the acetophenone, preferably in the range of from 52 to 42 K below the boiling point of the of the acetophenone. Further, In some embodiments, contacting in (c) is done at a temperature T₂, which may be in the range of from 160° C. to the temperature T, which is at least 7K below the boiling temperature of the acetophenone, preferably at a temperature T₂ in the range of from 165 to 185° C., more preferably in the range of from 170 to 180° C. or contacting in (c) may be done at a temperature T₂, which is in the range of from 37 to 17 K below the boiling point of the of the acetophenone, preferably in the range of from 32 to 22 K below the boiling point of the of the acetophenone. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of acetophenone at the temperature T at which the process is run. The skilled person can determine and/or adjust said autogenous pressure according to the steam pressure curve of acetophenone at a certain temperature T. Steam pressure curves of acetophenone are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) of the first solvent system and/or second solvent system comprise at least dimethyl sulfoxide (DMSO), preferably at least 90 weight-% of the one or more solvent(s) of the first solvent system and/or second solvent system, more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and/or second solvent system are DMSO, based on a total weight of the one or more solvent(s) of the first solvent system and second solvent system, respectively, being 100 weight-%, more preferably the one solvent is DMSO. In some embodiments, contacting in (b) is done at a temperature T₁, which may be in the range of from 10 to <170° C., wherein T₁ preferably may be in the range of from 140 to 160° C., more preferably in the range of from 150 to 160° C. or contacting in (b) is done at a temperature T₁, which may be in the range of from 49 to 29 K below the boiling point of the of the DMSO, preferably in the range of from 39 to 29 K below the boiling point of the of the DMSO. Further, In some embodiments, contacting in (c) is done at a temperature T₂, which may be in the range of from 160° C. to the temperature T, which is at least 1K below the boiling temperature of the DMSO, preferably at a temperature T₂ in the range of from 170 to 188° C., more preferably in the range of from 175 to 188° C., or contacting in (c) is done at a temperature T₂, which may be in the range of from 19 to 1 K below the boiling point of the of the DMSO, preferably in the range of from 14 to 1 K below the boiling point of the of the DMSO. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of DMSO at the temperature T at which the process is run. The skilled person can determine and/or adjust said autogenous pressure according to the steam pressure curve of DMSO at a certain temperature T. Steam pressure curves of DMSO are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the process, the one or more solvent(s) of the first solvent system and/or second solvent system comprise at least dihydrolevoglucosenon (Cyrene), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and/or second solvent system are Cyrene, based on a total weight of the one or more solvent(s) of the first solvent system and second solvent system, respectively, being 100 weight-%, more preferably the one solvent is Cyrene. In some embodiments, contacting in (b) is done at a temperature T₁, which may be in the range of from 10 to <170° C., wherein T₁ preferably may be in the range of from 140 to 160° C., more preferably in the range of from 150 to 160° C. or contacting in (b) is done at a temperature T₁, which may be in the range of from 86 to 66 K below the boiling point of the of the Cyrene, preferably in the range of from 76 to 66 K below the boiling point of the of the Cyrene. Further, In some embodiments, contacting in (c) is done at a temperature T₂, which may be in the range of from 160° C. to the temperature T, which is at least 7K below the boiling temperature of the Cyrene, preferably at a temperature T₂ in the range of from 160 to 180° C., more preferably in the range of from 160 to 170° C. or contacting in (c) is done at a temperature T₂, which may be in the range of from 66 to 46 K below the boiling point of the of the Cyrene, preferably in the range of from 66 to 56 K below the boiling point of the of the Cyrene. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of Cyrene at the temperature T at which the process is run. The skilled person can determine and/or adjust said autogenous pressure according to the steam pressure curve of Cyrene at a certain temperature T. Steam pressure curves of Cyrene are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

In some embodiments of the method, ethyl benzoate and butyl benzoate are excluded as solvent(s).

### GVL

In some embodiments of the method, the first and/or second solvent system comprises GVL, wherein preferably at least 90 weight-%, more preferably at least 95 weight-%, more preferably at least 98 weight-%, more preferably in the range of from 99 to 100 weight-%, based on the total weight of the first and second solvent system, respectively, being 100 weight-%, more preferably the first and/or second solvent system consist of GVL. In some embodiments, contacting in (b) is done at a temperature T₁, which may be in the range of from 10 to <170° C., wherein T₁ preferably may be in the range of from 140 to 160° C., more preferably in the range of from 150 to 160° C., or contacting in (b) is done at a temperature T₁, which may be in the range of from 65 to 45 K below the boiling point of the of the GVL, preferably in the range of from 55 to 45 K below the boiling point of the of the GVL. Further, In some embodiments, contacting in (c) is done at a temperature T₂, which may be in the range of from 160° C. to the temperature T, which is at least 7K below the boiling temperature of the GVL, preferably at a temperature T₂ in the range of from 175 to 195° C., more preferably in the range of from 180 to 190° C. or contacting in (c) is done at a temperature T₂, which may be in the range of from 30 to 10 K below the boiling point of the of the GVL, preferably in the range of from 25 to 15 K below the boiling point of the of the GVL. The contacting in (b) and/or, preferably and, in (c) is/are preferably done at a pressure in the range of from 800 to 1200 hPa. Preferably, the process is run at autogenous pressure, wherein the autogenous pressure may be higher than the ambient pressure of the surrounding area caused by the steam pressure of GVL at the temperature T at which the process is run. The skilled person can determine and/or adjust said autogenous pressure according to the steam pressure curve of GVL at a certain temperature T. Steam pressure curves of GVL are known to a person skilled in the art. The autogenous pressure may be lowered by purging, e.g. by a purging valve, preferably to a pressure between ambient pressure and lower 2000 hPa, preferably between 1200 hPa and 1800 hPa. Autogenous pressure is the pressure caused by the production system itself in a closed system, e.g. a pressure in the range from 800 to 3000 hPa.

### Polyalkylene Terephthalate Based Polymer

In some embodiments of the method, at least 40 weight-%, more preferably at least 50 weight-%, more preferably at least 60 weight-%, more preferably at least 70 weight-%, more preferably at least 80 weight-%, more preferably at least 90 weight-%, more preferably at least 95 weight-%, more preferably at least 98 weight-%, more preferably at least 99 weight-% of the polymeric material provided in (a) are polyalkylene terephthalate based polymer and additive, based on the total weight of the polymeric material provided in (a) being 100 weight-%.

In some embodiments of the method, at least 50 weight-%, preferably at least 60 weight-%, more preferably at least 70 weight-%, more preferably at least 80 weight-%, more preferably at least 90 weight-%, of the polymeric material are polyalkylene terephthalate based polymer, and in the range of from 0.01 to 20 weight-%, preferably in the range of from 0.1 to 10 weight-%, of the polymeric material are additive, based on the total weight of the polymeric material provided in (a) being 100 weight-%.

The “polyalkylene terephthalate based polymer” consists of either oxyethylen units or oxybutylen units and oxyterephthaloyl units, wherein in case of oxyethylen units, in the range of from 0 to 5 mol-% of the oxyterephthaloyl units are replaced by oxyisophthaloyl units and/or in the range of from 0 to 49 mol-% of the oxyethylen units are replaced by oxymethylene cyclohexylene methylene units. Preferably, the polyalkylene terephthalate based polymer is selected from the group consisting ofPET (polyethylene terephthalate), PETG (poly(ethylene terephthalate-co-1,4-cyclohexylene dimethylene terephthalate)), PETI (poly(ethylene terephthalate-co-isophthalate)), PBT (polybutylene terephthalate), and mixtures of two or more of these polymers, or the polyalkylene terephthalate based polymer is selected from the group consisting of PET (polyethylene terephthalate), PETI (poly(ethylene terephthalate-coisophthalate)), PBT (polybutylene terephthalate), and mixtures of two or three of these polymers. In some embodiments, the polyalkylene terephthalate based polymer comprises at least 80 weight-%, more preferably at least 85 weight-%, more preferably at least 90 weight-%, more preferably at least 95 weight-%, more preferably at least 96 weight-%, more preferably at least 97 weight-%, of PET based on the total weight of the polyalkylene terephthalate based polymer being 100 weight-% and/or, preferably and, at the outmost 20 weight-%, more preferably at the outmost 15 weight-%, more preferably at the outmost 10 weight-%, more preferably at the outmost 5 weight-%, more preferably at the outmost 4 weight-%, more preferably at the outmost 3 weight-%, more preferably at the outmost 2 weight-%, more preferably at the outmost 1 weight-%, of PETI, based on the total weight of the polyalkylene terephthalate based polymer being 100 weight-%.

In some embodiments, the “polyalkylene terephthalate based polymer” is a polyester based on 1,4-butanediol or 1,2-ethandiol, more preferably a polyester selected from the group consisting of a polymer based on 1,4-butanediol and terephthalic acid (polybutylene terephthalate, PBT), a polymer based on 1,2-ethanediol and terephthalic acid (polyethylene terephthalate, PET), a copolymer of 1,4-butanediol, adipic acid and terephthalic acid (polybutylenadipat-terephthalat, PBAT), a polymer of 1,2-ethanediol and 2,5-furandicarboxylic acid (polyethylene furanoate, PEF) and mixtures of two or more of these (co) polymers.

More preferably, the “polyalkylene terephthalate based polymer” comprises at least PET and/or PBT, more preferably the polyester is PET or PBT or a mixture of PET and PBT.

More preferably the polyalkylene terephthalate based polymer comprises or is PET.

In some embodiments of the method, the residue obtained in (b) and/or the re-obtained of (c) has a number average molecular weight Mn, which is >the Mn of the polyalkylene terephthalate based polymer comprised in the material provided in (a).

In some embodiments of the method, the residue obtained in (b) and/or the re-obtained polyalkylene terephthalate based polymer of (c) has a dispersity Mw/Mn (Mass average molecular weight Mw divided by number average molecular weight Mn) in the range of from 70 to 95%, preferably in the range of from 75 to 90% of the dispersity Mw/Mn of the polyalkylene terephthalate based polymer comprised in the polymeric material provided in (a) (100%).

### Ratio

In some embodiments of the method, polymeric material containing polyalkylene terephthalate based polymer and additive and solvent system are contacted in (b) in a mass-based ratio solvent system:material in the range of from 1:1 to 100:1, preferably in the range of from 1:1 to 50:1, more preferably in the range of from 1:1 to 20:1, more preferably in the range of from 1:1 to 10:1.

In some embodiments of the method, polymeric material provided in (a) or the residue of the polymeric material obtained in (b) are contacted in (c) in a mass-based ratio solvent system:material in the range of from 1:1 to 100:1, preferably in the range of from 1:1 to 50:1, more preferably in the range of from 1:1 to 20:1, more preferably in the range of from 1:1 to 10:1.

### Pressure

In some embodiments of the method, (b) and/or (c) are done at a pressure in the range of from 800 to 200,000 hPa. In some embodiments, (b) and/or (c) are done at a pressure in the range of from 800 to 1200 hPa.

### Additional Steps

In some embodiments of the method, (b) comprises:
(b.1) contacting the polymeric material with the solvent system at a temperature T₁, thereby obtaining a solvent system, which is enriched in dissolved additive and a residue of the polymeric material, which is depleted of said additive and comprises the polyalkylene terephthalate based polymer;
(b.2) separating the solvent system, which is enriched in dissolved additive and the residue of the polymeric material obtained in (b.1), preferably by a physical separation method, thereby obtaining a separated solvent system, which is enriched in dissolved additive compared to the solvent system provided in (a) and the residue of the polymeric material, which is depleted of said additive and comprises the polyalkylene terephthalate based polymer.

In some embodiments, the method, (b) comprises
(b.3) optionally washing the residue of the polymeric material, which comprises polyalkylene terephthalate based polymer obtained in (b.2);
(b.4) drying the residue of the polymeric material, which comprises polyalkylene terephthalate based polymer obtained in (b.2) or the washed residue of the polymeric material, which comprises polyalkylene terephthalate based polymer obtained in (b.3).

Washing in optional step (b.3) is preferably done with a solvent system having feature (s1.1), (s1.2) and optionally (s1.3) or a solvent system having features (s2.1), (s2.2) and optionally feature (s2.3) as described above, preferably with a solvent or solvent mixture comprising one or more of the solvent(s) of any one of the groups described above. In some embodiments, washing is done with a solvent selected from the group consisting of methanol, ethanol, propanol, isopropanol, acetonitrile, ethyl acetate, acetone, water or a mixture of two or more of these solvents. In some embodiments, the washing in optional step (b.3) is done with a solvent selected from the group consisting of methanol, ethanol, propanol, isopropanol, acetonitrile, ethyl acetate, acetone, water, GVL, or a mixture of two or more of these solvents. Drying in step (b.4) is preferably done under one or more conditions selected from the group consisting of a pressure in the range of from 1 to 1013 mbar; a temperature in the range of from 50 to 210° C., preferably in the range of from 60 to 180° C., more preferably in the range of from 80 to 160° C.; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen. Drying is done by one or more methods selected from the group consisting of contact drying, convection drying and radiation drying.

In some embodiments of the method, the polymeric material provided in (a) additionally comprises an elastic fiber. The elastic fiber comprises, preferably consists of one or more polyurethane based elastic fiber(s) and/or one or more polyester based elastic fiber(s), more preferably the elastic fiber comprises, preferably consists of one or more polyurethane based elastic fiber(s), wherein more preferably at least 40 weight-%, more preferably at least 45 weight-%, more preferably at least 50 weight-%, more preferably at least 55 weight-%, more preferably at least 60 weight-%, more preferably at least 65 weight-%, more preferably at least 70 weight-%, more preferably at least 75 weight-%, more preferably at least 80 weight-%, more preferably at least 85 weight-%, more preferably at least 90 weight-%, more preferably at least 95 weight-%, more preferably at least 99.9 weight-%, of the elastic fiber are polyurethane based elastic fiber(s), each based on the total weight of the elastic fiber being 100 weight-%.

In some embodiments of the method, (b.2) comprises:
(b.2.1) separating the solvent system, which is enriched in dissolved additive and the residue of the polymeric material obtained in (b.1), preferably by a physical separation method, thereby obtaining a separated solvent system, which is enriched in dissolved additive and enriched in dissolved elastic fiber compared to the solvent system provided in (a) and the residue of the polymeric material, which is depleted of said additive and said elastic fiber and comprises the polyalkylene terephthalate based polymer;
(b.2.2) separating the elastic fiber from the solvent system.

Separation of the elastic fiber, if present in the polymeric material, and additive is done by, for example, distillation, wherein the solvent system is removed and the remaining residue is put to a further use.

In step (c), i.e. when contacting with a second solvent system at a temperature T₂, polymeric material provided in (a), the residue of the polymeric material obtained in (b), the residue of the polymeric material obtained in (b.2), the washed residue of polymeric material obtained in (b.3) or the dried residue of polymeric material obtained in (b.3) is used.

In some embodiments of the method, (c) comprises:
(c. 1) contacting the polymeric material provided in (a) or the residue of the polymeric material obtained in (b), (b.2), (b.3) or (b.4) with a solvent system having a temperature T₂, obtaining a solvent system, which is enriched in dissolved polyalkylene terephthalate based polymer and optionally in additive;
(c.2) cooling the solvent system obtained in (c.1), which is enriched in dissolved polyalkylene terephthalate based polymer compared to the solvent provided in (a) and which optionally comprises additive, to a temperature below T₂, preferably to a temperature below 150° C., more preferably below 140° C., more preferably below 120° C., thereby obtaining a precipitated polyalkylene terephthalate based polymer and a solvent system, which is depleted in dissolved polyalkylene terephthalate based polymer and which optionally comprises additive.

Optionally, (c) comprises between (c.1) and (c.2) a heated filtration of the solvent system, which is enriched in dissolved polyalkylene terephthalate based polymer and optionally in additive, obtained in (c.1), more preferably at a temperature in the range of T₂±20° C., more preferably at a temperature in the range of T₂+10° C. In heated filtration, the solution, filter, and funnel are heated, preferably heated so that each has temperature T₂+20° C. or T₂+10° C. In some embodiments, it is preferred that the heated filtration is done at a pressure of ≥1bar, more preferably at a pressure in the range of from 1 bar to 30 bar, preferably in the range of from 1 to 10 bar, more preferably in the range of from 1 to 6 bar (heated pressure filtration). Other means and methods for the separation are known to the skilled person such as non-heated filtration or centrifugation. In some embodiments, the filter, preferably after the solvent system, which is enriched in dissolved polyalkylene terephthalate based polymer and optionally in additive, has passed through it, is rinsed with first solvent system for one or more times, preferably with first solvent system having the same composition as provided in (a) and used in (b), wherein the first solvent system preferably has temperature T₂+20° C. or T₂+10° C. In some embodiments, it is preferred that the solvent system, to which the cooling in (c.2) is applied, comprises the solvent system, which is enriched in dissolved polyalkylene terephthalate based polymer and optionally in additive obtained in (c.1), which had been subjected to filtration and the rising charge(s).

The temperature to which the cooling is done is preferably a temperature below 160° C., preferably below 150° C., more preferably below 140° C., more preferably below 120° C. and, in each case, above 0° C., preferably above 5° C., more preferably above 10° C.

In some embodiments of the process, (b) and/or (c) is/are done in counter current mode. For example, if the contacting of step (b) and/or (c) is done within a vessel, the solvent system enters the vessel from one direction (either side or top/bottom) and the colored polymeric material enters the vessel from an another, preferably an opposite, direction. In a preferred constellation wherein a vertically arranged vessel is used, the solvent system enters the vessel from the bottom and the colored polymeric material enters the vessel from the top. In some embodiments of the process, (b) and/or (c) is/are conducted under mechanical intermixing, wherein mechanical intermixing preferably comprises one or more methods selected from stirring, blending, and ultra sound.

In some embodiments, wherein the polymeric material provided in (a) comprises polyalkylene terephthalate based polymer, additive and at least one polymer different from polyalkylene terephthalate based polymer, the polymeric material provided in (a) is considered a polymer blend, wherein said at least one polymer different from polyalkylene terephthalate based polymer is in some embodiments selected from the group consisting of polypropylene (PP), polyethylene (PE), polyamide (PA), natural polymer such as cotton, viscose and/or linen and mixtures of two or more thereof. A “polymer blend” means a combination of at least one polymer with at least one further component, which is at least another polymer, these components combined with each other in any suitable way. For example, in case of at least two polymers, the polymers are intermixed, or one or more polymer(s) are embedded in and/or interwoven with one or more other polymer(s), or the polymers are aligned in separate layers, as well as hybrid forms of these combinations. PP, PE, PA and natural polymer such as cotton, viscose and/or linen are mostly not dissolved together with the polyalkylene terephthalate based polymer but rather remain undissolved; however, in some embodiments, the content of PA6 as polymer different from the polyalkylene terephthalate based polymer is reduced and preferably, the polymeric material comprising polyalkylene terephthalate based polymer provided in (a) does only comprises less than 10 weight-% of PA6. All polymers not soluble together with the polyalkylene terephthalate based polymer, preferably all polymers not soluble together with the polyalkylene terephthalate based polymer in a solvent system as defined above under the conditions of step (b) as defined above, are called herein “insoluble polymers”. In some embodiments, the polymeric material derives from textiles such as clothing, wherein the textiles are preferably subjected to a sorting process before the polymeric material is subjected to a method according to the present invention. A sorting process preferably comprises one or more NIR sorting steps, wherein textiles are analysed by near-infrared (NIR) spectroscopy and, based on the analytic result, sorted based on their composition. Thus, the polymeric material subjected to the method according to the present invention is preferably a pre-sorted, more preferably an NIR presorted, textile. The textile has preferably underwent a size reduction, more preferably a cutting/and or shredding step. Thus, the polymeric material subjected to the method according to the present invention is preferably a pre-sorted, more preferably an NIR presorted, and/or size reduced, more preferably shredded, textile. In some embodiments, the polymeric material subjected to the method according to the present invention is preferably a pre-sorted, more preferably an NIR presorted, and/or size reduced, more preferably shredded, textile, which has a content of PA6 of less than 10 weight-%, more preferably of less than 5 weight-%, more preferably of less than 4 weight-%, more preferably of less than 3 weight-%, more preferably of less than 2 weight-%, more preferably of less than 1 weight-%, based on the total weight of the polymeric material being 100 weight-%. Lowering the content of PA in the textile may provide an improved quality of the obtained polyester, in particular of the polyalkylene terephthalate based polymer.

In some embodiments of the method, (c.1), if at least one insoluble polymer is present in the polymeric material provided in (a) comprises:
(c. 1.1) contacting the polymeric material provided in (a), the residue of the polymeric material obtained in (b), (b.2), (b.3) or (b.4) with a solvent system having a temperature T₂, obtaining a solvent system, which is enriched in dissolved polyalkylene terephthalate based polymer and optionally in additive, and a residue comprising at least one insoluble polymer;
(c. 1.2) optionally separation of the solvent system, which is enriched in dissolved polyalkylene terephthalate based polymer and optionally in additive from the residue, thereby obtaining an insoluble polymer-free solvent system enriched in dissolved polyalkylene terephthalate based polymer and optionally in additive, and a residue comprising at least one insoluble polymer, wherein the separation is preferably done by heated filtration.

The separation in (c.1.2) is preferably done by heated filtration, more preferably by heated filtration, preferably at a temperature in the range of T₂±20° C., more preferably at a temperature in the range of T₂±10° C. In heated filtration, the solution, filter, and funnel are heated, preferably heated so that each has temperature T₂±20° C. or T₂±10° C. In some embodiments, it is preferred that the heated filtration is done at a pressure of ≥1bar, more preferably at a pressure in the range of from 1 bar to 30 bar, preferably in the range of from 1 to 10 bar, more preferably in the range of from 1 to 6 bar (heated pressure filtration). Other means and methods for the separation are known to the skilled person such as non-heated filtration or centrifugation. In some embodiments, the filter and the residue comprising at least one insoluble polymer (which is retained on the filter), preferably after the solvent system, which is enriched in dissolved polyalkylene terephthalate based polymer and optionally in additive, has passed through the filter, is rinsed with first solvent system for one or more times, preferably with first solvent system having the same composition as provided in (a) and used in (b), wherein the first solvent system preferably has temperature T₂±20° C. or T₂±10° C. In some embodiments, it is preferred that the solvent system, to which the cooling in (c.2) is applied, comprises the solvent system, which is enriched in dissolved polyalkylene terephthalate based polymer and optionally in additive obtained in (c.1), which had been subjected to filtration and the rising charge(s).

In some embodiments, the method comprises
(c.1.3) optionally washing the residue comprising at least one insoluble polymer obtained (c. 1.2); and/or
(c. 1.4) optionally drying the residue comprising at least one insoluble polymer obtained in (c. 1.2) or the washed residue comprising at least one insoluble polymer obtained in (c.1.3).

Washing in optional step (c.1.3) is preferably done with a solvent system having feature (s1.1), (s1.2) and optionally (s1.3) or a solvent system having features (s2.1), (s2.2) and optionally feature (s2.3) as described above, preferably with a solvent or solvent mixture comprising one or more of the solvent(s) of any one of the groups described above. In some embodiments, washing is done with a solvent selected from the group consisting of methanol, ethanol, propanol, isopropanol, acetonitrile, ethyl acetate, acetone, water or a mixture of two or more of these solvents. In some embodiments, the washing in optional step (c. 1.3) is done with a solvent selected from the group consisting of methanol, ethanol, propanol, isopropanol, acetonitrile, ethyl acetate, acetone, water, GVL, or a mixture of two or more of these solvents. Drying in step (c. 1.4) is preferably done under one or more conditions selected from the group consisting of a pressure in the range of from 1 to 1013 mbar; a temperature in the range of from 50 to 210° C., preferably in the range of from 60 to 180° C., more preferably in the range of from 80 to 150° C.; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen. Drying is done by one or more methods selected from the group consisting of contact drying, convection drying and radiation drying.

In some embodiments of the method, at least 40 weight-%, more preferably at least 50 weight-%, more preferably at least 60 weight-%, more preferably at least 70 weight-%, more preferably at least 80 weight-%, more preferably at least 90 weight-% of the material comprising polyalkylene terephthalate based polymer are polyalkylene terephthalate based polymer, and at the outmost 60 weight-%, more preferably at the outmost 50 weight-%, more preferably at the outmost 40 weight-%, more preferably at the outmost 30 weight-%, more preferably at the outmost 20 weight-%, more preferably at the outmost 10 weight-% of the material comprising polyalkylene terephthalate based polymer are at least one polymer different from polyalkylene terephthalate based polymer and at least one additive, each based on the total weight of the polymeric material comprising polyalkylene terephthalate based polymer being 100 weight-%.

In some embodiments, the method comprises
(d) separating the precipitated polyalkylene terephthalate based polymer obtained in (c.2) from the solvent system, thereby obtaining a precipitated polyalkylene terephthalate based polymer and the solvent system, which is depleted in dissolved polyalkylene terephthalate based polymer and which optionally comprises additive.

In some embodiments, the method comprises
(e) optionally washing the polyalkylene terephthalate based polymer obtained (d);
(f) drying the precipitated polyalkylene terephthalate based polymer obtained in (d) or the washed precipitated polyalkylene terephthalate based polymer obtained in (e).

Washing in optional step (e) is preferably done with a solvent system having feature (s1.1), (s1.2) and optionally (s1.3) or a solvent system having features (s2.1), (s2.2) and optionally feature (s2.3) as described above, preferably with a solvent or solvent mixture comprising one or more of the solvent(s) of any one of the groups described above. In some embodiments, washing is done with a solvent selected from the group consisting of methanol, ethanol, propanol, isopropanol, acetonitrile, ethyl acetate, acetone, water or a mixture of two or more of these solvents. In some embodiments, the washing in optional step (e) is done with a solvent selected from the group consisting of methanol, ethanol, propanol, isopropanol, acetonitrile, ethyl acetate, acetone, water, GVL, or a mixture of two or more of these solvents. Drying in step (f) is preferably done under one or more conditions selected from the group consisting of a pressure in the range of from 1 to 1013 mbar; a temperature in the range of from 50 to 210° C., preferably in the range of from 60 to 180° C., more preferably in the range of from 80 to 160° C.; drying time in the range of from 30 minutes to 24 hours; drying in an atmosphere comprising nitrogen, preferably in an atmosphere having at least 90 volume-%, more preferably 95 volume-%, more preferably at least 98 volume-% nitrogen. Drying is done by one or more methods selected from the group consisting of contact drying, convection drying and radiation drying.

In some embodiments, the method comprises recycling the separated solvent system obtained in (b.2) and/or the separated solvent system obtained in (d) at least partially to (b) and/or (c), optionally after one or more work-up step(s).

### 2^{nd} Aspect—Polyalkylene Terephthalate Based Polymer

A second aspect of the invention is directed to polyalkylene terephthalate based polymer obtained or obtainable from the method of the first aspect, preferably obtained or obtainable from step (b), (b.2), (c), (c.2), (d), (e) or (f), more preferably from step (f), of the method of the first aspect. All details and embodiments disclosed above for the first aspect apply also for the second aspect.

3^{rd} aspect—Use

A third aspect of the invention is directed to the use of the polyalkylene terephthalate based polymer of the second aspect for textile applications, fiber applications, packaging applications, plastic applications, automotive applications, electronic applications, preferably for the production of food packaging, beverage packaging, clothing, footwear, wire, cable, wherein preferably for textile applications, fiber applications, packaging applications, plastic applications, more preferably for the production of food packaging, beverage packaging, clothing and footwear. All details and embodiments disclosed above for the first aspect apply also for the third aspect.

Preferably, the polyalkylene terephthalate based polymer is used for:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

### 4^{th} Aspect—Method for Preparing a Product

A fourth aspect of the invention is directed to a method for preparing a product comprising
(I) providing polyalkylene terephthalate based polymer of the second aspect;
(II) preparing a textile, a fiber, a packaging, a plastic, an automotive part, an electronic part from the polyalkylene terephthalate based polymer provided in (I).

All details and embodiments disclosed above for the first aspect apply also for the fourth aspect.

Preferably, in (II)
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall, is prepared.

### 5^{th} Aspect—Method for Conversion (Polyalkylene Terephthalate Based Polymer)

A fifth aspect of the invention is directed to a method, preferably according to the first aspect, comprising the further step:
converting the re-obtained polyalkylene terephthalate based polymer obtained or obtainable by the method according to the first aspect;
to obtain a polymer product.

All details and embodiments disclosed above for the first aspect apply also for the fifth aspect. The polymer products to be obtained are as described above for the fourth aspect.

### 6^{th} Aspect—Method for Conversion (Residual Polymer(s))

A sixth aspect of the invention is directed to a method, preferably according to the first aspect, comprising the further step:
converting a residue obtainable by or obtained by the method according to the first aspect, preferably obtained or obtainable from step (c. 1.2), more preferably the residue comprisesing at least one insoluble polymer selected from PP, PE, PA, natural polymer, viscose and linen obtainable by or obtained by the method according to the first aspect, preferably obtained or obtainable from step (c.1.2), and/or
converting the elastic fiber residue obtainable by or obtained by the method according to the first aspect, preferably obtained or obtainable from step (b.2.2);
to obtain one or more monomer, polymer or polymer product.

All details and embodiments disclosed above for the first aspect apply also for the sixth aspect.

Preferably, the monomer is a di- or polyol; preferably butandiol; aldehyde; preferably formaldehyde; di- or polyisocyanate; preferably methylene diphenyl diisocyanate (MDI), polymeric methylene diphenyl diisocyanate (pMDI), toluene diisocyanate (TDI), hexamethylenediisocyanate (HDI) or isophoronediisocyanate (IPDI); amide; preferably caprolactam; alkene; preferably styrene, ethene and norbornene; alkyne, (di) ester; preferably methyl methacrylate; mono or diacid; preferably adipic acid or terephthalic acid; diamine; preferably hexamethylenediamine, nonanediamine; or sulfones; preferably 4,4′-dichlorodiphenyl sulfone.

Preferably, the polymer is and/or the polymer product comprises polyamide (PA); preferably PA 6 or PA 66; polyisocyanate polyaddition product; preferably polyurethane (PU), thermoplastic polyurethane (TPU), polyurea or polyisocyanurate (PIR); low-density polyethylene (LDPE), highdensity polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (PTFE), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); or copolymer or mixture thereof.

Preferably, the polymer and/or the polymer product is/are or is/are a part of:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

Preferably, the content of the at least one insoluble polymer and/or of the elastic fiber in the polymer and/or polymer product is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or
wherein the content of the at least one insoluble polymer and/or of the elastic fiber in the polymer and/or polymer product is 100 weight-% or less, preferably 95 weight-% or less, more preferably 90 weight-% or less, more preferably 50 weight-% or less, more preferably 25 weight-% or less, more preferably 10 weight-% or less; and
preferably wherein the content is determined based on identity preservation and/or segregation and/or mass balance and/or book and claim chain of custody models, preferably based on mass balance, preferably the International Sustainability and Carbon Certification (ISCC) standard.

The converting steps to obtain the monomer, polymer or polymer product may comprise one or more synthesis steps and can be performed by conventional synthesis and technics well known to a person skilled in the art. Independent of the person skilled in the art to assess novelty and inventive step of the independent claim(s), the person skilled in the art to perform the converting step(s) is preferably from the technical field(s) pyrolysis, gasification, remonomerization, depolymerization, synthesis, production of monomers, polymers and polymer compounds, and/or its further processing (e.g. extrusion, injection molding). Examples of the step(s) of the conversion is/are described in “Industrial Organic Chemistry”, 3. volume, Wiley-VCH, 1997, ISBN: 978-3-527-28838-0, “Kunststoffhandbuch”, 11 volumes in 17 sub-volumes, Carl Hanser Verlag; especially volume 6, “Polyamide”, 1. edition, 1966, volume 7, “Polyurethane”, 3. edition, 1993, and volume 8, “Polyester”, 2. edition 1973; “Industrial Organic Chemistry”, 3. volume, Wiley-VCH, 1997, ISBN: 978-3-527-28838-0, “Injection Molding Reference Guide, 4th edition, CreateSpace Independent Publishing Platform, 2011, ISBN: 978-1466407824, EP 0989146 A1, EP 1460094 A1, WO 2006034800 A1, EP 1529792 A1, WO 2006042674 A1, EP 0364854 A2, U.S. Pat. No. 5,506,275 A, EP 0897402 A1, WO 2015082316 A1, WO 2021021855 A1, WO 2021126938 A1, WO 2021021902 A1, WO 2021092311 A1, WO 2008155271 A1, WO 2013139827 A1, each of which is incorporated herein by reference.

The present invention is further illustrated by the following embodiments and combinations of embodiments as indicated by the respective dependencies and back-references. In particular, it is noted that in each instance where a range of embodiments is mentioned, for example in the context of a term such as “The . . . of any of embodiments 1 to 4”, every embodiment in this range is meant to be explicitly disclosed for the skilled person, i.e. the wording of this term is to be understood by the skilled person as being synonymous to “The . . . of any of embodiments 1, 2, 3, and 4”.
1. A method for removal of additives from a polymeric material, which contains a polyalkylene terephthalate based polymer and an additive, the method comprising:
   (a) providing the polymeric material and providing a first solvent system and/or a second solvent system;
   (b) contacting the polymeric material with a first solvent system at a temperature T₁, which is <170° C., thereby obtaining a first solvent system, which is enriched in dissolved additive and a residue of the polymeric material, which is depleted of said additive and comprises the polyalkylene terephthalate based polymer, wherein the first solvent system comprises one or more solvents, wherein
      (s1.1) the solvent system has Hansen solubility parameters with respect to
         energy from dispersion forces between molecules (δDₛₛ),
         energy from dipolar intermolecular force between molecules (δPₛₛ) and
         energy from hydrogen bonds between molecules (ÖHₛₛ),
      which fulfill equitation 1

(11)²≥4(δDₛₛ-17.5)²+(ÖPₛₛ-7.5)²+(δHₛₛ-7.5)² [equitation 1]
(s1.2) each solvent of the solvent system has a boiling point at 1013 hPa of at least 150° C.;
and/or
(c) contacting the polymeric material provided in (a) or the residue of the polymeric material obtained in (b) with a second solvent system at a temperature T₂, wherein T₂>T₁ and T₂ is at least 1K, preferably at least 7K, below the boiling temperature of the solvent in the second solvent system, which has the lowest boiling point, thereby obtaining a second solvent system, which is enriched in dissolved polyalkylene terephthalate based polymer and optionally enriched in additive compared to the second system provided in (a); and re-obtaining polyalkylene terephthalate based polymer from the second solvent system obtained;
   wherein the second solvent system comprises one or more solvents and
   (s2.1) has Hansen solubility parameters with respect to
      energy from dispersion forces between molecules (δDₛₛ),
      energy from dipolar intermolecular force between molecules (δPₛₛ) and
      energy from hydrogen bonds between molecules (δHₛₛ),
   which fullfill equitation 2

(8.8)²≥4(δDₛₛ-20)²+(δPₛₛ-11.8)²+(δHₛₛ-4.5)² [equitation 2]
(s2.2) each solvent of the solvent system has a boiling point at 1013 hPa of at least 160° C.; and
(s2.3) solvents having a functional group selected from the group consisting of hydroxyl (OH), amino (NH₂), carboxyl (COOH), and thiol (SH) are excluded.
2. The method of embodiment 1, wherein in the first solvent system used for step (b) (s1.3) solvents having a functional group selected from the group consisting of hydroxyl (OH), amino (NH₂), carboxyl (COOH), and thiol (SH) are excluded.
3. The method of embodiment 1 or 2, wherein contacting in (b) is done at a temperature T₁, which is in the range of from 10 to <170° C., wherein T₁ is preferably in the range of from 110 to 165° C., more preferably in the range of from 120 to 150° C.
4. The method of any one of embodiments 1 to 3, wherein contacting in (c) is done at a temperature T₂, which is in the range of from 160° C. to the temperature T, which is at least 7K below the boiling temperature of the solvent in the solvent system, which has the lowest boiling point.
5. The method of any one of embodiments 1 to 4, wherein the additive is selected from the group consisting of softener, water repellent, flame retardant, UV filter, plasticizer and mixtures of two or more thereof.
6. The method of any one of embodiments 1 to 5, wherein colorants and optical brighteners are excluded as additive.
7. The method according to any one of embodiments 1 to 6, wherein at least 90 weight-%, preferably at least 95 weight-%, more preferably at least 98 weight-%, more preferably in range of from 99 to 100 weight-%, of the solvent system consist of one or more solvent(s), based on the total weight of the solvent system being 100 weight-%.
8. The method according to any one of embodiments 1 to 7, wherein at least 90 weight-%, preferably at least 95 weight-%, more preferably at least 98 weight-%, more preferably in the range of from 99 to 100 weight-%, of the first and second solvent system, respectively, consist of one solvent, which fulfills equation 1, based on the total weight of the first and second solvent system, respectively, being 100 weight-%.
9. The method according to any one of embodiments 1 to 8, wherein the one or more solvent(s) of the first solvent system and/or second solvent system is/are selected from the group consisting of N, N-dimethylbenzamide, N,N-dimethylphenylacetamide, 1,4-benzoquinone, acetophenone, dimethyl terephthalate, 1,3,5-trimethoxybenzene, 2-phenylacetophenone, N-methylcaprolactam, methylbenzoate, methyl-4-methoxybenzoate, butylene carbonate, propylene-glycol-dibenzoate, N-ethylpyrrolidone, benzophenone, di-benzyl malonate, N-ethyl-caprolactam, methyl 2-(5-oxotetrahydrofuran-3-yl)acetate (FAME), propiophenone, N-methoxypropyl-pyrrolidone, 1,4-cyclohexanedione, cyclohexane-carbonate, N-methoxyethyl-pyrrolidone, N,N-diethylphenylacetamide, phenyl acetate, 1-(2-hydroxyethyl) pyrrolidin-2-one acetate (HEPAc), N,N-diethylbenzamide, isopropyl-benzoate, cyclohexyl phenyl ketone, phenylacetic acid ethylester, phenylacetat, N-methyl-morpholine, benzyl-propionate, benzylacetate, Neopentyl-glycol-dibenzoate, retrahydrofurfuryl acetate, N-methyl-imidazole, benzyl butyrate, 2-pyrrolidone, 2-phenoxyethanol propionate, 2-phenoxyethyl isobutyrate, N,N-dipropylbenzamide, N,N-dimethylacetamide, N,N-diethylacetamide, dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), delta-valerolactone, gamma butyrolactone, dimethylsulfoxide, methyl 5-(dimethylamino)-2-methyl-5-oxopentanoate (Rhodiasolv Polarclean), caprolactam, phen etyl acetate, methyl phenylacetate, benzyl benzoate, N,Ndimethyllactamide (Agnique AMD 3L), and dimethyl sulfoxide (DMSO).
10. The method according to any one of embodiments 1 to 9, wherein the one or more solvent(s) of the first solvent system and/or second solvent system is/are selected from the group consisting of dihydrolevoglucosenon (Cyrene), propylenecarbonate, caprolactone, dimethylisosorbide, N-butylpyrrolidone, t-butylpyrrolidone, methyl-1-methyl-5-oxopyrrolidine-3-carboxylate (MMOC), gamma-valerolactone (GVL), delta-valerolactone, gammabutyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, propyl benzoate, and dimethyl sulfoxide (DMSO).
11. The method according to any one of embodiments 1 to 10, wherein the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, propyl benzoate, and GVL.
12. The method according to any one of embodiments 1 to 11, wherein the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, and propyl benzoate.
13. The method according to any one of embodiments 1 to 12, wherein the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), delta-valerolactone, gamma-butyrolactone, methyl 5-(dimethylamino)-2-methyl-5-oxopentanoate (Rhodiasolv®Polarclean), caprolactam, phenethyl acetate, methyl phenylacetate, benzyl benzoate, phenyl benzoate, methyl benzoate, and propyl benzoate.
14. The method according to any one of embodiments 1 to 13, wherein the one or more solvent(s) of the first solvent system and/or second solvent system is/are selected from the group consisting of propylenecarbonate, N-butylpyrrolidone, t-butylpyrrolidone, methyl-1-methyl-5-oxopyrrolidine-3-carboxylate (MMOC), methyl 5-(dimethylamino)-2-methyl-5-oxopentanoate (Rhodiasolv®Polarclean), and phenethyl acetate.
15. The process of any one of embodiments 1 to 14, wherein the one or more solvent(s) of the first solvent system and/or second solvent system is/are selected from the group consisting of gamma valerolactone (GVL), N-butylpyrrolidone (NBP), propylenecarbonate, acetophenone dimethyl sulfoxide (DMSO), dihydrolevoglucosenon (Cyrene) and mixtures of two or more thereof, or from the group consisting of N-butylpyrrolidone (NBP), propylenecarbonate, acetophenone dimethyl sulfoxide (DMSO), dihydrolevoglucosenon (Cyrene) and mixtures of two or more thereof.
16. The process of any one of embodiments 1 to 15, wherein the one or more solvent(s) i of the first solvent system and/or second solvent system s/are selected from the group consisting of GVL, NBP, propylenecarbonate, acetophenone, DMSO and mixtures of two or more thereof, or from the group consisting of NBP, propylenecarbonate, acetophenone, DMSO and mixtures of two or more thereof.
17. The process of any one of embodiments 1 to 16, wherein the one or more solvent(s) of the first solvent system and/or second solvent system is/are selected from the group consisting of GVL, NBP, propylenecarbonate, acetophenone and mixtures of two or more thereof, or from the group consisting of NBP, propylenecarbonate, acetophenone and mixtures of two or three thereof.
18. The process of any one of embodiments 1 to 17, wherein the one or more solvent(s) of the first solvent system and/or second solvent system, comprise at least N-butylpyrrolidone, preferably at least 90 weight-% of the one or more solvent(s) of the first solvent system and second solvent system, respectively, more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and second solvent system, respectively, are N-butylpyrrolidone, based on a total weight of the one or more solvent(s) of the first solvent system and second solvent system, respectively, being 100 weight-%, more preferably the of the first solvent system and/or second solvent system is/are N-butylpyrrolidone; or
   wherein the one or more solvent(s) of the first solvent system and/or second solvent system comprise at least propylenecarbonate, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and second solvent system, respectively, are propylenecarbonate, based on a total weight of the one or more solvent(s) of the first solvent system and second solvent system, respectively, being 100 weight-%, more preferably the one solvent of the first solvent system and/or second solvent system is/are propylenecarbonate; or
   wherein the one or more solvent(s) of the first solvent system and/or second solvent system comprise at least acetophenone, preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and second solvent system, respectively, are acetophenone, based on a total weight of the one or more solvent(s) of the first solvent system and second solvent system, respectively, being 100 weight-%, more preferably the one solvent of the first solvent system and/or second solvent system is/are acetophenone; or
   wherein the one or more solvent(s) of the first solvent system and/or second solvent system, comprise at least dimethyl sulfoxide (DMSO), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and second solvent system, respectively, are DMSO, based on a total weight of the one or more solvent(s) of the first solvent system and second solvent system, respectively being 100 weight-%, more preferably the one solvent of the first solvent system and/or second solvent system is/are DMSO; or
   wherein the one or more solvent(s) of the first solvent system and/or second solvent system comprise at least dihydrolevoglucosenon (Cyrene), preferably at least 90 weight-% of the one or more solvent(s), more preferably at least 95 weight-%, more preferably at least 98 weight-%, more preferably at least 99 weight-%, more preferably at least 99.5 weight-%, more preferably at least 99.9 weight-%, of the one or more solvent(s) of the first solvent system and second solvent system, respectively, are Cyrene, based on a total weight of the one or more solvent(s) of the first solvent system and second solvent system, respectively, being 100 weight-%, more preferably the one solvent of the first solvent system and/or second solvent system is/are Cyrene.
19. The method of any one of embodiments 1 to 18, wherein ethyl benzoate and butyl benzoate are excluded as solvent(s).
20. The method according to any one of embodiments 1 to 19, wherein the first and/or second solvent system comprises GVL, wherein preferably at least 90 weight-%, more preferably at least 95 weight-%, more preferably at least 98 weight-%, more preferably in the range of from 99 to 100 weight-%, based on the total weight of the first and second solvent system respectively, being 100 weight-%, more preferably the first/and or second solvent system is/are of GVL.
21. The method of any one of embodiments 1 to 20, wherein at least 40 weight-%, more preferably at least 50 weight-%, more preferably at least 60 weight-%, more preferably at least 70 weight-%, more preferably at least 80 weight-%, more preferably at least 90 weight-%, more preferably at least 95 weight-%, more preferably at least 98 weight-%, more preferably at least 99 weight-% of the polymeric material provided in (a) are polyalkylene terephthalate based polymer and additive, based on the total weight of the polymeric material provided in (a) being 100 weight-%.
22. The method of any one of embodiments 1 to 21, wherein at least 50 weight-%, preferably at least 60 weight-%, more preferably at least 70 weight-%, more preferably at least 80 weight-%, more preferably at least 90 weight-%, of the polymeric material are polyalkylene terephthalate based polymer, and in the range of from 0.01 to 20 weight-%, preferably in the range of from 0.1 to 10 weight-%, of the polymeric material are additive, based on the total weight of the polymeric material provided in (a) being 100 weight-%.
23. The method of any one of embodiments 1 to 22, wherein the residue obtained in (b) and/or the re-obtained polyalkylene terephthalate based polymer of (c) has a number average molecular weight Mn, which is >the Mn of the polyalkylene terephthalate based polymer comprised in the material provided in (a).
24. The method of any one of embodiments 1 to 23, wherein the residue obtained in (b) and/or the re-obtained polyalkylene terephthalate based polymer of (c) has a dispersity Mw/Mn (Mass average molecular weight Mw divided by number average molecular weight Mn) in the range of from 70 to 95%, preferably in the range of from 75 to 90% of the dispersity Mw/Mn of the polyalkylene terephthalate based polymer comprised in the polymeric material provided in (a) (100%).
25. The method of any one of embodiments 1 to 24, wherein the polyalkylene terephthalate based polymer consists of either oxyethylen units or oxybutylen units and oxyterephthaloyl units, wherein in case of oxyethylen units, in the range of from 0 to 5 mol-% of the oxyterephthaloyl units are replaced by oxyisophthaloyl units and/or in the range of from 0 to 49 mol-% of the oxyethylen units are replaced by oxymethylene cyclohexylene methylene units; wherein more preferably, the polyalkylene terephthalate based polymeris selected from the group consisting of PET (polyethylene terephthalate), PETI (poly(ethylene terephthalate-co-isophthalate)), PBT (polybutylene terephthalate), and mixtures of two or three of these polymers; wherein more preferably the polyalkylene terephthalate based polymer comprises or is PET.
26. The method of any one of embodiments 1 to 25, wherein polymeric material containing polyalkylene terephthalate based polymer and additive and solvent system are contacted in (b) in a mass-based ratio solvent system:material in the range of from 1:1 to 100:1, preferably in the range of from 1:1 to 50:1, more preferably in the range of from 1:1 to 20:1, more preferably in the range of from 1:1 to 10:1.
27. The method of any one of embodiments 1 to 26, wherein polymeric material provided in (a) or the residue of the polymeric material obtained in (b) are contacted in (c) in a mass based ratio solvent system:material in the range of from 1:1 to 100:1, preferably in the range of from 1:1 to 50:1, more preferably in the range of from 1:1 to 20:1, more preferably in the range of from 1:1 to 10:1.
28. The method of any one of embodiments 1 to 27, wherein (b) and/or (c) are done at a pressure in the range of from 800 to 200,000 hPa.
29. The method of any one of embodiments 1 to 28, wherein (b) comprises:
   (b.1) contacting the polymeric material with the solvent system at a temperature T₁, thereby obtaining a solvent system, which is enriched in dissolved additive and a residue of the polymeric material, which is depleted of said additive and comprises the polyalkylene terephthalate based polymer;
   (b.2) separating the solvent system, which is enriched in dissolved additive and the residue of the polymeric material obtained in (b.1), preferably by a physical separation method, thereby obtaining a separated solvent system, which is enriched in dissolved additive compared to the solvent system provided in (a) and the residue of the polymeric material, which is depleted of said additive and comprises the polyalkylene terephthalate based polymer; and preferably:
   (b.3) optionally washing the residue of the polymeric material, which comprises polyalkylene terephthalate based polymer obtained in (b.2);
   (b.4) drying the residue of the polymeric material, which comprises polyalkylene terephthalate based polymer obtained in (b.2) or the washed residue of the polymeric material, which comprises polyalkylene terephthalate based polymer obtained in (b.3).
30. The method of any one of embodiments 1 to 29, wherein the polymeric material provided in (a) additionally comprises an elastic fiber.
31. The method of embodiment 30, wherein (b.2) comprises:
   (b.2.1) separating the solvent system, which is enriched in dissolved additive and the residue of the polymeric material obtained in (b.1), preferably by a physical separation method, thereby obtaining a separated solvent system, which is enriched in dissolved additive and enriched in dissolved elastic fiber compared to the solvent system provided in (a) and the residue of the polymeric material, which is depleted of said additive and said elastic fiber and comprises the polyalkylene terephthalate based polymer;
   (b.2.2) separating the elastic fiber from the solvent system.
32. The method of any one of embodiments 1 to 31, wherein (c) comprises:
   (c.1) contacting the polymeric material provided in (a) or the residue of the polymeric material obtained in (b), (b.2), (b.3) or (b.4) with a solvent system having a temperature T₂, obtaining a solvent system, which is enriched in dissolved polyalkylene terephthalate based polymer and optionally in additive;
   (c.2) cooling the solvent system obtained in (c.1), which is enriched in dissolved polyalkylene terephthalate based polymer compared to the solvent provided in (a) and which optionally comprises additive, to a temperature below T₂, preferably to a temperature below 150° C., more preferably below 140° C., more preferably below 120° C., thereby obtaining a precipitated polyalkylene terephthalate based polymer and a solvent system, which is depleted in dissolved polyalkylene terephthalate based polymer and which optionally comprises additive.
33. The method of any one of embodiments 1 to 32, wherein (c. 1), if at least one insoluble polymer is present in the polymeric material provided in (a) comprises:
   (c. 1.1) contacting the polymeric material provided in (a) or the residue of the polymeric material obtained in (b), (b.2), (b.3) or (b.4) with a solvent system having a temperature T₂, obtaining a solvent system, which is enriched in dissolved polyalkylene terephthalate based polymer and optionally in additive, and a residue comprising at least one insoluble polymer;
   (c. 1.2) optionally separation of the solvent system, which is enriched in dissolved polyalkylene terephthalate based polymer and optionally in additive from the residue, thereby obtaining an insoluble polymer-free solvent system enriched in dissolved polyalkylene terephthalate based polymer and optionally in additive, and a residue comprising at least one insoluble polymer, wherein the separation is preferably done by heated filtration.
34. The method of any one of embodiments 27 to 33 comprising
   (d) separating the precipitated polyalkylene terephthalate based polymer obtained in (c.2) from the solvent system, thereby obtaining a precipitated polyalkylene terephthalate based polymer and the solvent system, which is depleted in dissolved polyalkylene terephthalate based polymer and which optionally comprises additive.
35. The method of any one of embodiments 27 to 34 comprising
   (e) optionally washing the polyalkylene terephthalate based polymer obtained in (d);
   (f) drying the precipitated polyalkylene terephthalate based polymer obtained in (d) or the washed precipitated polyalkylene terephthalate based polymer obtained in (e).
36. The method of any one of embodiments 31 to 35 comprising recycling the separated solvent system obtained in (b.2) and/or the separated solvent system obtained in (d) at least partially to (b) and/or (c), optionally after one or more work-up step(s).
37. Polyalkylene terephthalate based polymer obtained or obtainable from the method of any one of embodiments 1 to 36, preferably obtained or obtainable from step (b), (b.2), (b.4), (c), (c.2), (d), (e) or (f), more preferably from step (f).
38. Use of the polyalkylene terephthalate based polymer of embodiment 37 for textile applications, fiber applications, packaging applications, plastic applications, automotive applications, electronic applications, preferably for the production of food packaging, beverage packaging, clothing, footwear, wire, cable, wherein preferably for textile applications, fiber applications, packaging applications, plastic applications, more preferably for the production of food packaging, beverage packaging, clothing and footwear.
39. The use of embodiment 38 for:
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or
   a part of a construction; preferably a rotor blade, insulating material, frame, housing, wall, coating, or separating wall.
40. A method for preparing a product comprising
   (I) providing polyalkylene terephthalate based polymer of embodiment 37;
   (II) preparing a textile, a fiber, a packaging, a plastic, an automotive part, an electronic part from the polyalkylene terephthalate based polymer provided in (I).
41. The method of embodiment 40, wherein in (II)
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or
   a part of a construction; preferably a rotor blade, insulating material, frame, housing, wall, coating, or separating wall, is prepared.
42. Method, preferably according to any one of embodiments 1 to 36, comprising the further step:
   converting the re-obtained polyalkylene terephthalate based polymer obtained or obtainable by the method according to any one of embodiments 1 to 36 to obtain a polymer product.
43. Method, preferably according to any one of embodiments 1 to 36, comprising the further step:
   converting a residue obtainable by or obtained by the method according to any one of embodiments 1 to 36, preferably obtained or obtainable from step (c. 1.2), more preferably the residue comprising at least one insoluble polymer selected from PP, PE, PA, natural polymer, viscose and linen obtainable by or obtained by the method according to any one of embodiments 1 to 36, preferably obtained or obtainable from step (c.1.2), and/or
   converting the elastic fiber residue obtainable by or obtained by the method according to any one of embodiments 1 to 36, preferably obtained or obtainable from step (b.2.2);
to obtain one or more monomer, polymer or polymer product.
44. Method according to embodiment 43,
   wherein the monomer is a di- or polyol; preferably butandiol; aldehyde; preferably formaldehyde; di- or polyisocyanate; preferably methylene diphenyl diisocyanate (MDI), polymeric methylene diphenyl diisocyanate (pMDI), toluene diisocyanate (TDI), hexamethylenediisocyanate (HDI) or isophoronediisocyanate (IPDI); amide; preferably caprolactam; alkene; preferably styrene, ethene and norbornene; alkyne, (di) ester; preferably methyl methacrylate; mono or diacid; preferably adipic acid or terephthalic acid; diamine; preferably hexamethylenediamine, nonanediamine; or sulfones; preferably 4,4′-dichlorodiphenyl sulfone.
45. Method according to embodiment 43 or 44,
   wherein the polymer is and/or the polymer product comprises polyamide (PA); preferably PA 6 or PA 66; polyisocyanate polyaddition product; preferably polyurethane (PU), themoplastic polyurethane (TPU), polyurea or polyisocyanurate (PIR); low-density polyethylene (LDPE), high-density polyethylene (HDPE), polyethylene (PE), polypropylene (PP), polyvinyl chloride (PVC), polyvinyl acetate (PVA), polystyrene (PS), poly acrylonitrile butadiene styrene (ABS), poly styrene acrylonitrile (SAN), poly acrylate styrene acrylonitrile (ASA), polytetrafluoroethylene (PTFE), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polybutylene terephthalate (PBT), polybutylene adipate coterephthalate (PBAT), polyester (PES), polyether sulfone (PESU), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO), polylactic acid (PLA), polysulfone (PSU), polyphenylene sulfone (PPSU), polycarbonate (PC), polyether ether ketone (PEEK), poly(p-phenylene oxide) (PPO), poly(p-phenylene ether) (PPE); or copolymer or mixture thereof.
46. Method according to any one of embodiments 43 to 45,
   wherein the polymer and/or the polymer product is/are or is/are a part of:
      a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
      a cloth; preferably shirt, trousers, pullover, boot, shoe, shoe sole, tight or jacket;
      an electrical part; preferably electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
      a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
      a packaging for the food industry; preferably mono- or multi-layer blown film, cast film (mono- or multi-layer), biaxially stretched film, or laminating film; or
      a part of a construction; preferably a rotor blade, insulating material, frame, housing, wall, coating, or separating wall.
47. Method according to any one of embodiments 43 to 46,
   wherein the content of the at least one insoluble polymer and/or of the elastic fiber in the polymer and/or polymer product is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or
   wherein the content of the at least one insoluble polymer and/or of the elastic fiber in the polymer and/or polymer product is 100 weight-% or less, preferably 95 weight-% or less, more preferably 90 weight-% or less, more preferably 50 weight-% or less, more preferably 25 weight-% or less, more preferably 10 weight-% or less; and
   preferably wherein the content is determined based on identity preservation and/or segregation and/or mass balance and/or book and claim chain of custody models, preferably based on mass balance, preferably the International Sustainability and Carbon Certification (ISCC) standard.

The present invention is further illustrated by the following reference examples, comparative examples, and examples.

### EXAMPLES

### Methods for Analytics

### NMR

The presence of additives was checked by ¹H-, ¹⁹F-, ³¹P- and ²⁹Si-NMR spectroscopy. For this, samples were measured containing the additives before and after purification steps. All spectra were recorded at room temperature (20-25° C.) on a Bruker Avance III 400 spectrometer, operating at 400.33 MHz for 1H, 376.69 MHz for 19F, 162.06 MHz for 31P and and 79.53 MHz for 29Si, respectively. The spectrometer was equipped with a 5 mm z-gradient broadband observe probe head, optimized for x-nucleus detection. In all cases, an amount of sample was dissolved in deuterated sulfuric acid and transferred into 5 mm NMR tubes for measurement. The deuterated solvent D₂SO₄ was purchased from Sigma-Aldrich and used as received.

¹H 1D spectra were recorded using the zg30 pulse program (direct excitation with a 30° pulse angle) with a sampling of 64 k data points. 16 transients were summed up per spectrum, the relaxation delay D1 was chosen as 1 second.

¹⁹F 1D spectra were recorded using the zg pulse program (direct excitation with a 90° pulse angle) with a sampling of 512 k data points. 128 transients were summed up per spectrum, the relaxation delay D1 was chosen as 1 second.

³¹P 1D spectra were recorded using the zg30 pulse program (direct excitation with a 30° pulse angle) with a sampling of 128 k data points. 64 transients were summed up per spectrum, the relaxation delay D1 was chosen as 1 second.

²⁹Si 1D spectra were recorded using the zgig pulse program (direct excitation with a 90° pulse angle and inverse gated proton decoupling), with a sampling of 64 k data points. 1024 transients were summed up per spectrum, the relaxation delay D1 was chosen as 10 seconds. In addition, a ¹H-²⁹Si HMBC was measured for the samples. Here, 64 transients were summed up per spectrum, the relaxation delay D1 was chosen as 1 second.

For processing the Bruker TopSpin 4.0.9 software was used with the following conditions for each spectrum:
¹H: 32 k data points and an exponential window function with a line broadening of 0.3 Hz
¹⁹F: 256 k data points and an exponential window function with a line broadening of 0.5 Hz
³¹P: 64 k data points and an exponential window function with a line broadening of 0.3 Hz
²⁹Si: 32 k data points and an exponential window function with a line broadening of 1.0 Hz Automatic baseline correction with a polynomial of 5 was performed for each spectrum, phase correction and integration was performed manually by the user.

### Chemicals

| | |
|---|---|
| (Chemical) name | Abbreviation |

Polymeric material

| | |
|---|---|
| polyethylene terephthalate | PET |

solvents

| | |
|---|---|
| water | — |
| acetone | — |
| gamma-valerolactone | GVL |
| ethylene carbonate | — |
| propylene glycol methyl ether | PM |
| acetic acid | — |

additives

| | |
|---|---|
| softener | Silicone based softener |
| Water repellant | silicones/polymers/ |
| | paraffine |
| Water repellant | fluorocarbon-based |
| flame retardant | phosphorus based |
| UV-filter | hydroxyphenone- |
| | derivatives |
| additive to increase | polyamide-polymer- |
| hygroscopicity | based |

### Reference Example 1: General Procedure for Removal of Additives at the Stage of PET Discoloration

0.5 g of PET textile containing additives was cut/shredded into pieces and placed in a reaction vessel (e.g. flask, tube, reaction vessel). The solvent system was added (in mass-based ratio solvent:polymeric material 100:1 to 1:1, preferred 10:1-1:1) and the mixture was heated by use of a suitable heating system (e.g. oil bath, heating blocks, mini-plant vessels) to a temperature in the range of <170° C., preferably in the range of from 10 to <170° C., more preferably in the range of from 110 to 165° C., more preferably in the range of from 120 to 150° C. After 0.5-8 h the mixture was filtered, whereby solvent system enriched in additive and additive-depleted polymeric material was obtained. The additive-depleted material was washed with a small amount of solvent system. For an easy removal of solvent system and a faster drying process of the additive-depleted polymeric material pieces, small amounts of acetone can be used in a second washing step. The thus obtained additive-depleted polymeric material was dried (for example in a vacuum compartment dryer).

### Reference Example 2: General Procedure for Removal of Additives at the Stage of PET Dissolution

10 g of PET textile containing additives was cut/shredded into pieces and placed in a reaction vessel (e.g. flask, tube, reaction vessel). The solvent system was added (in mass-based ratio solvent:polymeric material 100:1 to 1:1, preferred 10:1-1:1) and the mixture was heated by use of a suitable heating system (e.g. oil bath, heating blocks, mini-plant vessels) to 185° C. under inter gas atmosphere, wherein PET was fully dissolved upon visual inspection. After 1-30 min the mixture was filtered (e.g. heated pressure filtration). The filtrate was allowed to cool-down wherein PET precipitated. The precipitated PET was filtrated wherein additive-depleted PET and additive-enriched solvent system was obtained. The additive-depleted PET was washed with a small amount of solvent system. For an easy removal of solvent system and a faster drying process of the re-obtained additive-depleted PET powder, small amounts of acetone can be used in a second washing step. The thus obtained solid was dried (for example in a vacuum compartment dryer).

### Example 1: PET Textile Containing Softener

A first part of a PET textile containing a silicone-based softener was treated according to Reference Example 1, and a second part thereof was treated according to Reference Example 2.

The samples were analyzed by NMR before any treatment and after the final drying step. The Si-HMBC NMR spectra are shown in FIG. 1 (before treatment), FIG. 2 (after treatment according to Reference Example 1) and FIG. 3 (after treatment according to Reference Example 2). As apparent from the complete lack of Si signals in the spectra after treatment, the softener was completely removed while the PET related signals remained unchanged.

### Example 2: PET Textile Containing Water Repellent

A first part of a PET textile containing a silicone/polymer/paraffine-based water repellent was treated according to Reference Example 1, and a second part thereof was treated according to Reference Example 2.

The samples were analyzed by NMR before any treatment and after the final drying step. The 1H-NMR spectra are shown in FIG. 4 (before treatment), FIG. 5 (after treatment according to Reference Example 1) and FIG. 6 (after treatment according to Reference Example 2). As apparent from the complete lack of signals in the region below 5.5 ppm in the spectra after treatment, the water repellent was completely removed while the PET related signals remained unchanged.

### Example 3: PET Textile Containing Water Repellent

A first part of a PET textile containing a fluorocarbon-based water repellent was treated according to Reference Example 1, and a second part thereof was treated according to Reference Example 2.

The samples were analyzed by NMR before any treatment and after the final drying step. The 19F-NMR spectra are shown in FIG. 7 (before treatment), FIG. 8 (after treatment according to Reference Example 1) and FIG. 9 (after treatment according to Reference Example 2). As apparent from the complete lack of F signals in the spectra after treatment, the water repellent was completely removed.

### Example 4: PET Textile Containing Flame Retardant

A first part of a PET textile containing a phosphorous-based flame retardant was treated according to Reference Example 1, and a second part thereof was treated according to Reference Example 2.

The samples were analyzed by 31P-NMR before any treatment and after the final drying step. The NMR spectra are shown in FIG. 10 (before treatment), FIG. 11 (after treatment according to Reference Example 1) and FIG. 12 (after treatment according to Reference Example 2). As apparent from the complete lack of signals in the spectra after treatment, the flame retardant was completely removed.

### Example 5: PET Textile Containing UV-Filter

A first part of a PET textile containing a hydroxyphenone-based UV-filter was treated according to Reference Example 1, and a second part thereof was treated according to Reference Example 2.

The samples were analyzed by NMR before any treatment and after the final drying step. The NMR spectra are shown in FIG. 13 (before treatment), FIG. 14 (after treatment according to Reference Example 1) and FIG. 15 (after treatment according to Reference Example 2). As apparent from the almost complete lack of signals in the region below 5.5 ppm in the spectra after treatment, the additive was completely removed while the PET related signals remained unchanged.

### Comparative Example 1: PET Textile Containing Softener with a Comparative Solvent

A PET textile containing a silicone-based softener was treated according to Reference Example 1 with ethylene carbonate, which is a solvent which neither fulfills (s1.1) and (s1.2) nor (s.2.1) and (s2.2) and (s2.3).

The samples were analyzed by NMR before any treatment and after the final drying step. The Si-HMBC NMR spectra are shown in FIG. 1 (before treatment) and FIG. 16 (after treatment according to Reference Example 1). As apparent from the presence of Si signals in the spectra after treatment, the softener was not removed while the PET related signals remained unchanged.

### Comparative Example 2: PET Textile Containing Water Repellent with a Comparative Solvent Vent

A PET textile containing a fluorocarbon-based water repellent was treated according to Reference Example 1 with ethylene carbonate, which is a solvent which neither fulfills (s1.1) and (s1.2) nor (s2.1) and (s2.2) and (s2.3).

The samples were analyzed by NMR before any treatment and after the final drying step. The 19F-NMR spectra are shown in FIG. 7 (before treatment) and FIG. 17 (after treatment according to Reference Example 1). As apparent from the presence of F signals in the spectra after treatment, the water repellent was not removed.

### Comparative Example 3: PET Textile Containing Phosphorous-Based Flame Retardant with a Comparative Solvent

A PET textile containing a phosphorous-based flame retardant was treated according to Reference Example 1 with ethylene carbonate, which is a solvent which neither fulfills (s1.1) and (s1.2) nor (s2.1), (s2.2) and (s2.3).

The samples were analyzed by 31P-NMR before any treatment and after the final drying step. The NMR spectra are shown in FIG. 10 (before treatment) and FIG. 18 (after treatment according to Reference Example 1). As apparent from the presence of signals in the spectra after treatment, the flame retardant was not removed.

### Comparative Example 4: PET Textile Containing Softener with a Comparative Solvent of the Prior Art

US 2023/0090987 A1 discloses a solvent system based on PM and acetic acid. PM already has a boiling point at 1013 hPa of less than 150° C. (120° C.) and acetic acid is an acid.
4a: A PET textile containing a silicone-based softener was treated with a solvent system disclosed in Examples 1 to 6 of US 2023/0090987 A1 at a mass-based ratio solvent:polymeric material ratio of 20:1: 10 g of PET textile containing a silicone-based softener were treated with a mixture of 180 g PM and 20 g acetic acid (1:20, textile to solvent ratio) at 120° C. (reflux conditions, limited due to the presence of acetic acid) for 6 h under nitrogen atmosphere. The samples were analyzed by NMR before any treatment and after the final drying step. The Si-HMBC NMR spectra are shown in FIG. 1 (before treatment) and FIG. 19 (after treatment according to the above). As apparent from the presence of Si signals in the spectra after treatment, the softener was not removed while the PET related signals remained unchanged.
4b: A PET textile containing a silicone-based softener was treated with a solvent system disclosed in Examples 1 to 6 of US 2023/0090987 A1 at a mass-based ratio solvent:polymeric material ratio of 10:1: 10 g PET textile containing a silicone-based softener were treated with a mixture of 90 g PM and 10 g acetic acid (1:10, textile to solvent ratio) at 120° C. (reflux conditions, limited due to the presence of acetic acid) for 6 h under nitrogen atmosphere. The samples were analyzed by NMR before any treatment and after the final drying step. The Si-HMBC NMR spectra are shown in FIG. 1 (before treatment) and FIG. 20 (after treatment according to the above). As apparent from the presence of Si signals in the spectra after treatment, the softener was not removed while the PET related signals remained unchanged.

### Comparative Example 5: PET Textile Containing Phosphorous-Based Flame Retardant with a Solvent of the Prior Art

US 2023/0090987 A1 discloses a solvent system based on PM and acetic acid. PM already has a boiling point at 1013 hPa of less than 150° C. (120° C.) and acetic acid is an acid.
5a: A PET textile containing a phosphorous-based flame retardant was treated with a solvent system disclosed in Examples 1 to 6 of US 2023/0090987 A1 at a mass-based ratio solvent:polymeric material ratio of 20:1: 10 g of PET textile containing a phosphorous-based flame retardant were treated with a mixture of 180 g PM and 20 g acetic acid (1:20) at 120° C. (reflux conditions, limited due to the presence of acetic acid) for 6 h under nitrogen atmosphere. The samples were analyzed by 31P-NMR before any treatment and after the final drying step. The NMR spectra are shown in FIG. 10 (before treatment) and FIG. 21 (after treatment according to the above). As apparent from the presence of signals in the spectra after treatment, the flame retardant was not removed.
5b: A PET textile containing a phosphorous-based flame retardant was treated with a solvent system disclosed in Examples 1 to 6 of US 2023/0090987 A1 at a mass-based ratio solvent:polymeric material ratio of 10:1: 10 g PET textile containing a phosphorous-based flame retardant were treated with a mixture of 90 g PM and 10 g acetic acid (1:10) at 120° C. (reflux conditions, limited due to the presence of acetic acid) for 6 h under nitrogen atmosphere. The samples were analyzed by 31P-NMR before any treatment and after the final drying step. The NMR spectra are shown in FIG. 10 (before treatment) and FIG. 22 (after treatment according to the above). As apparent from the presence of signals in the spectra after treatment, the flame retardant was not removed.

### SUMMARY

It could be shown, that with the methods of Reference Example 1, Reference Example 2, (A) treating the additive-containing polymer with a solvent system fulfilling (s1.1) and (s1.2) and optionally (s1.3) for additive removal without dissolution of the PET and (B) treating the additivecontaining polymer with a solvent system fulfilling (s2.1), (s2.2) and (s2.3) for additive removal including dissolution of PET, a complete removal of additives could be achieved, while leaving the polymeric structure of PET degradation free. Furthermore, it was shown that using a solvent which did not fulfill (s1.1) and (s1.2) and optionally (s1.3) additive removal without dissolution of the PET was not possible. In addition, solvent systems such as described in US 2023/0090987 A1 were found to be unable to remove additives.

### SHORT DESCRIPTION OF THE FIGURES

FIG. 1 shows a Si-HMBC spectrum of a PET textile containing a silicone-based softener before treatment/Example 1;

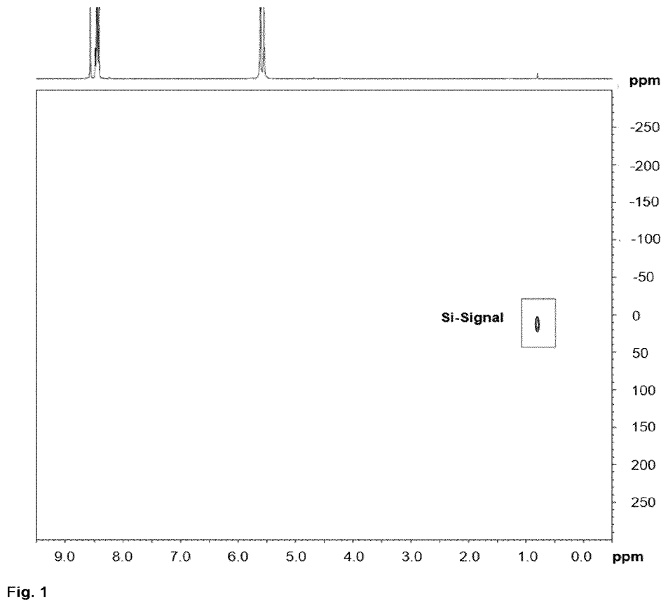

FIG. 2 shows a Si-HMBC spectrum of a PET textile containing a silicone-based softener after treatment according to Reference Example 1/Example 1;

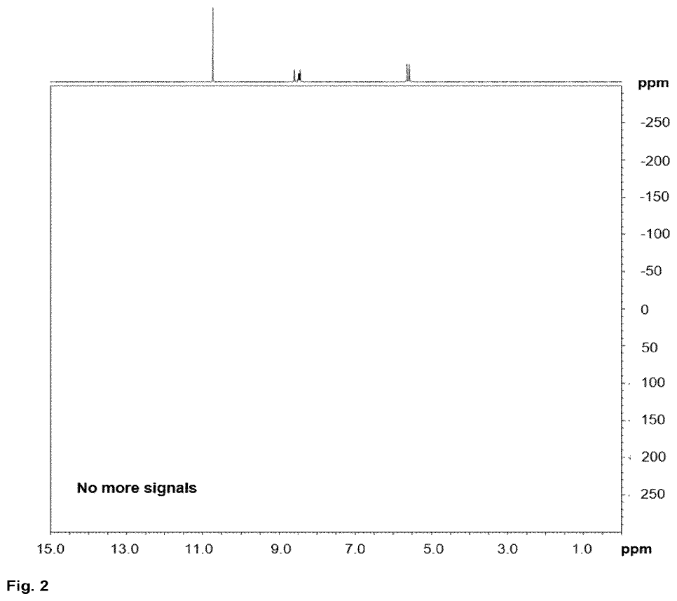

FIG. 3 shows a Si-HMBC spectrum of a PET textile containing a silicone-based softener after treatment according to Reference Example 2/Example 1;

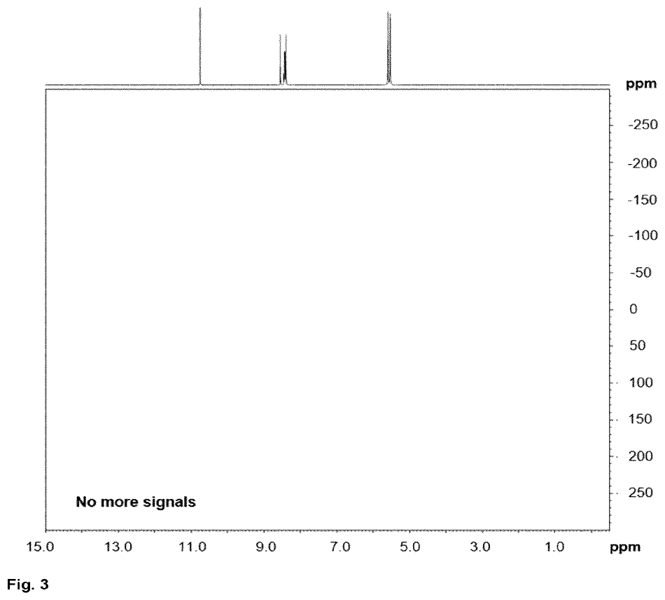

FIG. 4 shows a 1H-NMR spectrum of a PET textile containing a silicone/polymer/paraffine-based water repellent before treatment/Example 2;

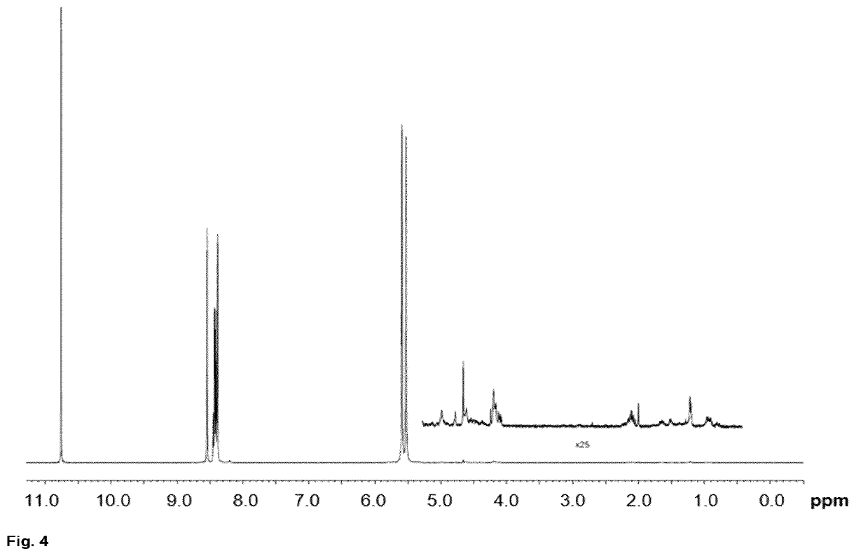

FIG. 5 shows a 1H-NMR spectrum of a PET textile containing a silicone/polymer/paraffine-based water repellent after treatment according to Reference Example 1/Example 2;

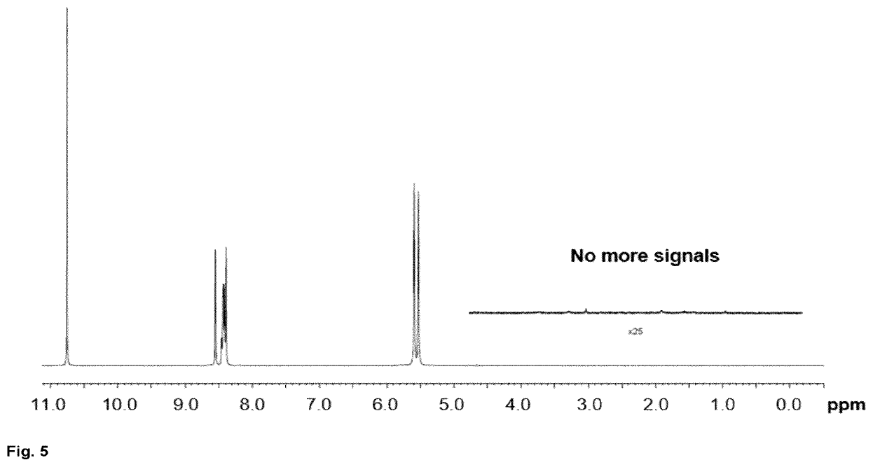

FIG. 6 shows n 1H-NMR spectrum of a PET textile containing a silicone/polymer/paraffine-based water repellent after treatment according to Reference Example 2/Example 2;

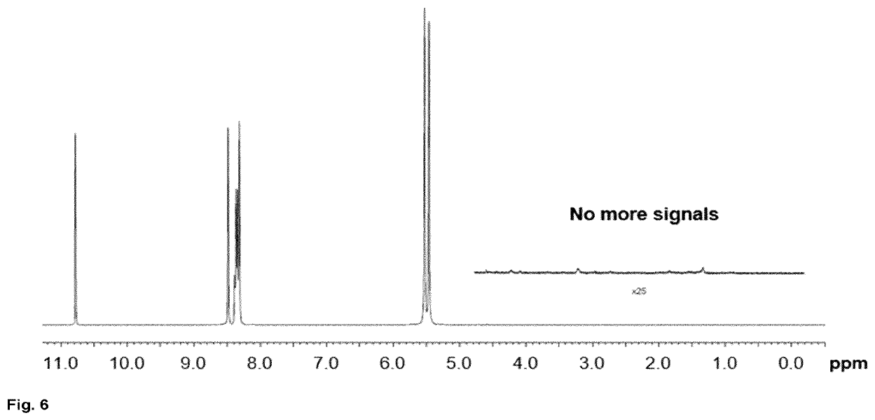

FIG. 7 shows a 19F-NMR-spectrum of a PET textile containing a fluorocarbon-based water repellent before treatment/Example 3;

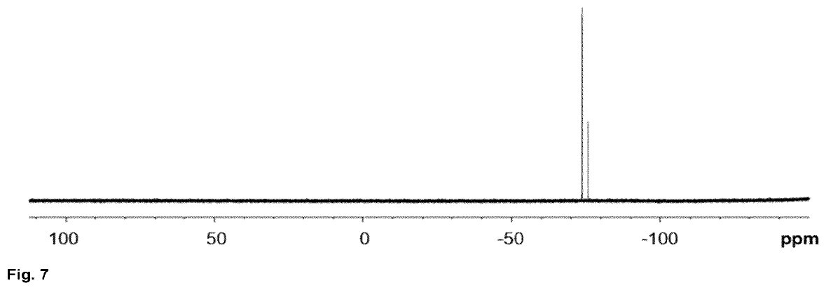

FIG. 8 shows a 19F-NMR-spectrum of a PET textile containing a fluorocarbon-based water repellent after treatment according to Reference Example 1/Example 3;

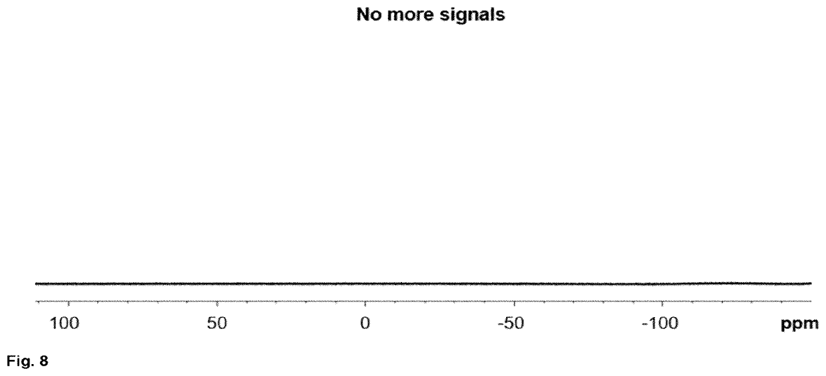

FIG. 9 shows a 19F-NMR-spectrum of a PET textile containing a fluorocarbon-based water repellent after treatment according to Reference Example 2/Example 3;

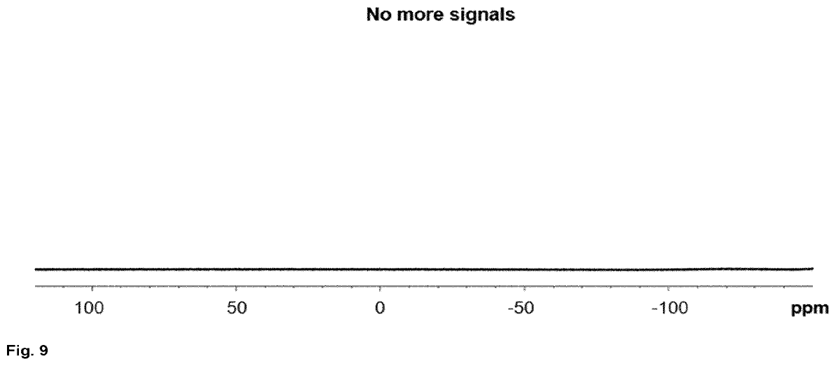

FIG. 10 shows a 31P-NMR-spectrum of a PET textile containing a phosphorous-based flame retardant before treatment/Example 4;

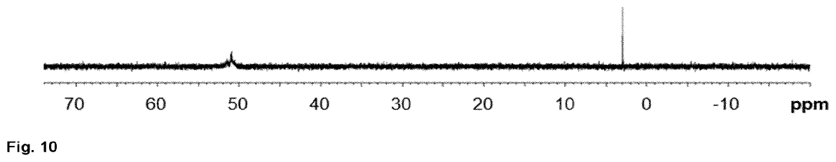

FIG. 11 shows a 31P-NMR-spectrum of a PET textile containing a phosphorous-based flame retardant after treatment according to Reference Example 1/Example 4;

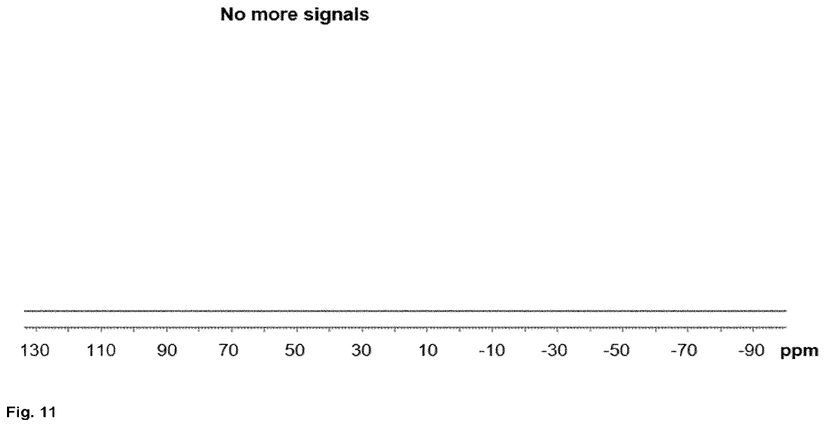

FIG. 12 shows a 31P-NMR-spectrum of a PET textile containing a phosphorous-based flame retardant after treatment according to Reference Example 2/Example 4;

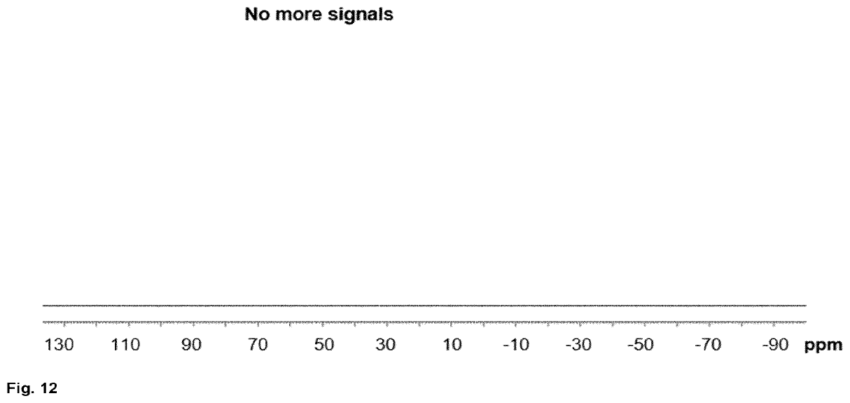

FIG. 13 shows a 1H-NMR spectrum of a PET textile containing a hydroxyphenone-based UV-filter before treatment/Example 5;

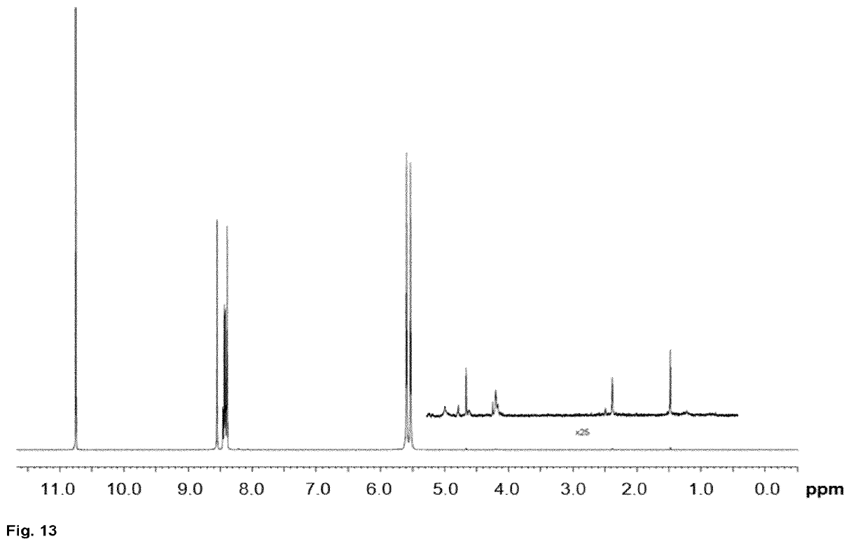

FIG. 14 shows a 1H-NMR spectrum of a PET textile containing a hydroxyphenone-based UV-filter after treatment according to Reference Example 1/Example 5;

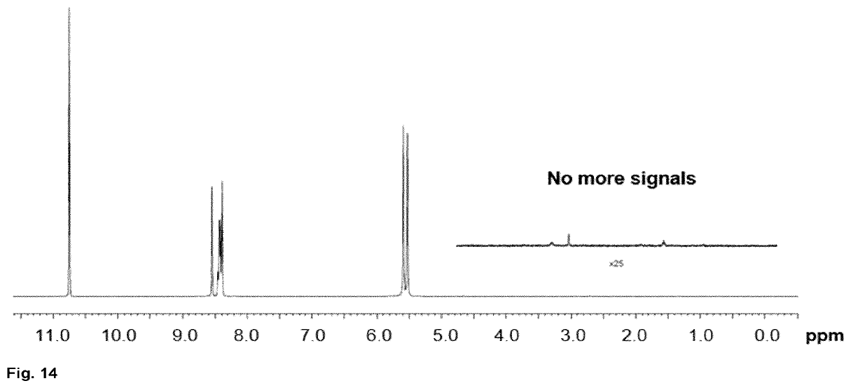

FIG. 15 shows a 1H-NMR spectrum of a PET textile containing a hydroxyphenone-based UV-filter after treatment according to Reference Example 2/Example 5.

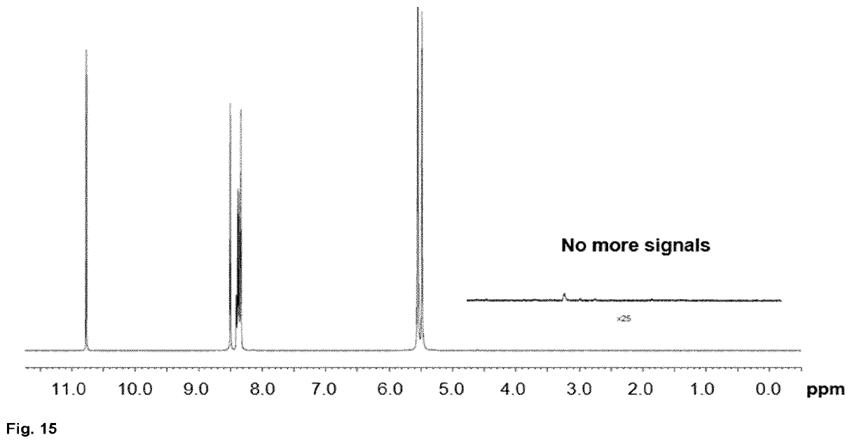

FIG. 16 shows a Si-HMBC spectrum of a PET textile containing a silicone-based softener after treatment with ethylene carbonate according to Reference Example 1/Comparative Example 1 (Si-HMBC spectrum of starting material is shown in FIG. 1).

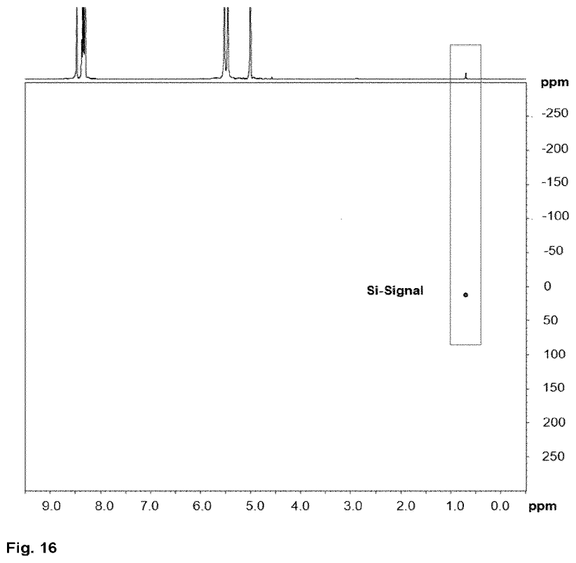

FIG. 17 shows a 19F-NMR-spectrum of a PET textile containing a fluorocarbon-based water repellent after treatment with ethylene carbonate according to Reference Example 1/Comparative Example 2 (19F-NMR-spectrum of starting material is shown in FIG. 7).

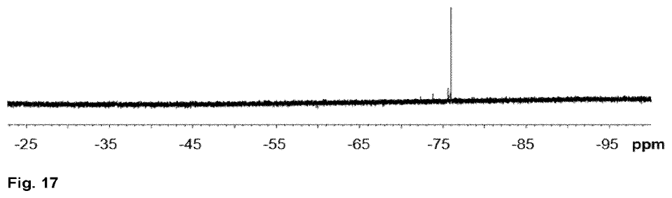

FIG. 18 shows a 31P-NMR-spectrum of a PET textile containing a phosphorous-based flame retardant after treatment according to Reference Example 1/Comparative Example 3 (31P-NMR-spectrum of starting material is shown in FIG. 10).

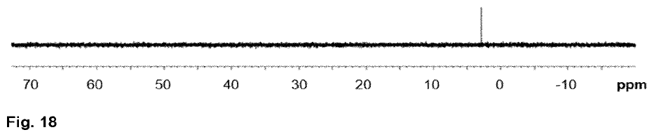

FIG. 19 shows a Si-HMBC spectrum of a PET textile containing a silicone-based softener after treatment with PM/acetic acid according to Comparative Example 4a (Si-HMBC spectrum of starting material is shown in FIG. 1).

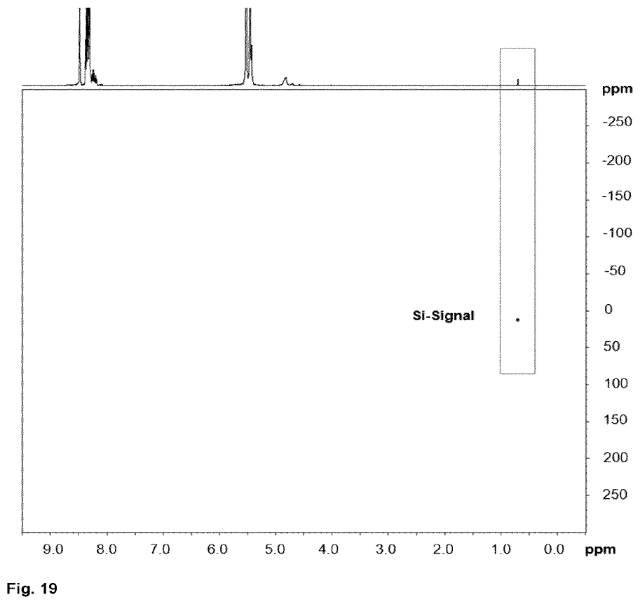

FIG. 20 shows a Si-HMBC spectrum of a PET textile containing a silicone-based softener after treatment with PM/acetic acid according to Comparative Example 4b (Si-HMBC spectrum of starting material is shown in FIG. 1).

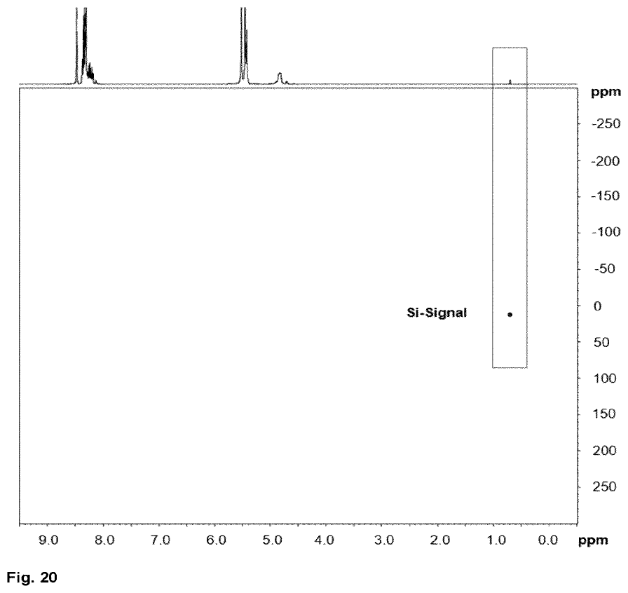

FIG. 21 shows a 31P-NMR-spectrum of a PET textile containing a phosphorous-based flame retardant after treatment according to Comparative Example 5a (31P-NMR-spectrum of starting material is shown in FIG. 10).

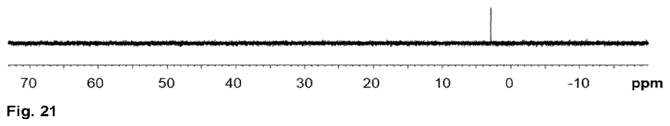

FIG. 22 shows a 31P-NMR-spectrum of a PET textile containing a phosphorous-based flame retardant after treatment according to Comparative Example 5b (31P-NMR-spectrum of starting material is shown in FIG. 10).

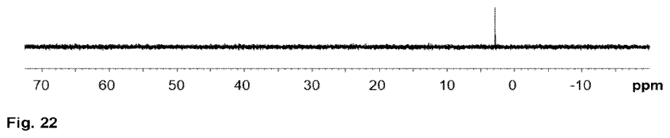

### CITED LITERATURE

“Industrial Organic Chemistry”, 3. volume, Wiley-VCH, 1997, ISBN: 978-3-527-28838-0,
“Kunststoffhandbuch”, Carl Hanser Verlag; vol. 6, “Polyamide”, 1. edition, 1966,
“Kunststoffhandbuch”, Carl Hanser Verlag; vol. 7, “Polyurethane”, 3. edition, 1993,
“Kunststoffhandbuch”, Carl Hanser Verlag; vol. 8, “Polyester”, 2. edition 1973;
“Industrial Organic Chemistry”, 3. volume, Wiley-VCH, 1997, ISBN: 978-3-527-28838-0,
“Injection Molding Reference Guide, 4th edition, CreateSpace Independent Publishing Platform, 2011, ISBN: 978-1466407824,
EP0989146 A1
EP 1460094 A1
WO2006034800 A1
EP 1529792 A1
WO 2006042674 A1
EP 0364854 A2
U.S. Pat. No. 5,506,275 A
EP 0897402 A1
WO 2015082316 A1
WO 2021021855 A1
WO 2021126938 A1
WO 2021021902 A1
WO 2021092311 A1
WO 2008155271 A1
WO 2013139827 A1

1. A method for removal of additives from a polymeric material, which contains a polyalkylene terephthalate based polymer and an additive, which is selected from the group consisting of softener, water repellent, flame retardant, UV filter, plastiziser, and mixtures of two or more thereof,
the method comprising:
(a) providing the polymeric material and providing a first solvent system and/or a second solvent system;
(b) contacting the polymeric material with a first solvent system at a temperature T1, which is <170° C., thereby obtaining a first solvent system, which is enriched in dissolved additive and a residue of the polymeric material, which is depleted of said additive and comprises the polyalkylene terephthalate based polymer,
wherein the first solvent system comprises one or more solvents, wherein
(s1.1) the solvent system has Hansen solubility parameters with respect to energy from dispersion forces between molecules (δDₛₛ),
energy from dipolar intermolecular force between molecules (δPₛₛ) and
energy from hydrogen bonds between molecules (δHₛₛ),
which fulfill equation 1:
(11)²≥4(δDss-17.5)²+(δPss-7.5)²+(δHss-7.5)²
and
(s1.2) each solvent of the solvent system has a boiling point at 1013 hPa of at least 150° C.;
and/or
(c) contacting the polymeric material provided in (a) or the residue of the polymeric material obtained in (b) with a second solvent system at a temperature T2, wherein T2>T1 and T2 is at least 7K below the boiling temperature of the solvent in the second solvent system, which has the lowest boiling point, thereby obtaining a second solvent system, which is enriched in dissolved polyalkylene terephthalate based polymer and optionally enriched in additive compared to the second solvent system provided in (a); and re-obtaining polyalkylene terephthalate based polymer from the second solvent system obtained;
wherein the second solvent system comprises one or more solvents and
(s2.1) has Hansen solubility parameters with respect to
energy from dispersion forces between molecules (δDss),
energy from dipolar intermolecular force between molecules (δPss) and
energy from hydrogen bonds between molecules (δHss),
which fulfill equation 2;
(8.8)²≥4(δDss-20)²+(δPss-11.8)²+(δHss-4.5)²
(s2.2) each solvent of the solvent system has a boiling point at 1013 hPa of at least 160° C.; and
(s2.3) solvents having a functional group selected from the group consisting of hydroxyl (OH), amino (NH₂), carboxyl (COOH), and thiol (SH) are excluded.

2. The method according to claim 1, wherein in the first solvent system used for step (b),
(s1.3) solvents having a functional group selected from the group consisting of hydroxyl (OH), amino (NH₂), carboxyl (COOH), and thiol (SH) are excluded.

3. The method according to claim 1, wherein the contacting in (b) is done at a temperature T1, which is in the range of from 10 to <170° C.; and/or
wherein the contacting in (c) is done at a temperature T2, which is in the range of from 160° C. to the temperature T, which is at least 7K below the boiling temperature of the solvent in the solvent system, which has the lowest boiling point.

4. The method according to claim 1, wherein the one or more solvent(s) of the first solvent system and/or second solvent system is/are selected from the group consisting of N,N-dimethylbenzamide, N,Ndimethylphenylacetamide, 1,4-benzoquinone, acetophenone, dimethyl terephthalate, 1,3,5-trimethoxybenzene, 2-phenylacetophenone, N-methylcaprolactam, methylbenzoate, methyl4-methoxybenzoate, butylene carbonate, propylene-glycol-dibenzoate, N-ethylpyrrolidone, benzophenone, di-benzyl malonate, N-ethyl-caprolactam, methyl 2-(5-oxotetrahydrofuran-3-yl)acetate (FAME), propiophenone, N-methoxypropyl-pyrrolidone, 1,4-cyclohexanedione, cyclohexane-carbonate, N-methoxyethyl-pyrrolidone, N,N-diethylphenylacetamide, phenyl acetate, 1-(2-hydroxyethyl) pyrrolidin-2-one acetate (HEPAc), N,N-diethylbenzamide, isopropyl-benzoate, cyclohexyl phenyl ketone, phenylacetic acid ethylester, phenylacetat, Nmethyl-morpholine, benzyl-propionate, benzylacetate, Neopentyl-glycol-dibenzoate, retrahydrofurfuryl acetate, N-methyl-imidazole, benzyl butyrate, 2-pyrrolidone, 2-phenoxyethanol propionate, 2-phenoxyethyl isobutyrate, N,N-dipropylbenzamide, N,Ndimethylacetamide, N,N-diethylacetamide, dihydrolevoglucosenon (Cyrene), propylenecarbonate, caprolactone, dimethylisosorbide, N-butylpyrrolidone, tbutylpyrrolidone, methyl-1-methyl-5-oxopyrrolidine-3-carboxylate (MMOC), gammavalerolactone (GVL), delta-valerolactone, gamma butyrolactone, dimethylsulfoxide, methyl 5-(dimethylamino)-2-methyl-5-oxopentanoate (Rhodiasolv Polarclean), caprolactam, phen etyl acetate, methyl phenylacetate, benzyl benzoate, N,N-dimethyllactamide (Agnique AMD 3L), dimethyl sulfoxide (DMSO), and mixtures of two or more thereof.

5. The method according to claim 1, wherein the first solvent system and/or second solvent system comprises GVL.

6. The method according to claim 1, wherein the polyalkylene terephthalate based polymer comprises or is PET.

7. The method according to claim 1, wherein (b) comprises:
(b.1) contacting the polymeric material with the solvent system at a temperature T1, thereby obtaining a solvent system, which is enriched in dissolved additive and a residue of the polymeric material, which is depleted of said additive and comprises the polyethylene terephthalate based polymer; and
(b.2) separating the solvent system, which is enriched in dissolved additive and the residue of the polymeric material obtained in (b.1), preferably by a physical separation method, thereby obtaining a separated solvent system, which is enriched in dissolved additive compared to the solvent system provided in (a) and the residue of the polymeric material, which is depleted of said additive and comprises the polyalkylene terephthalate based polymer.

8. The method according to claim 1, wherein the polymeric material provided in (a) additionally comprises an elastic fiber.

9. The method according to claim 1, wherein (c) comprises:
(c.1) contacting the polymeric material provided in (a) or the residue of the polymeric material obtained in (b) or (b.2) with a solvent system having a temperature T2, obtaining a solvent system, which is enriched in dissolved polyalkylene terephthalate based polymer and optionally in additive; and optionally, if at least one insoluble polymer is present in the polymeric material provided in (a), (c.1) comprises:
(c.1.1) contacting the polymeric material provided in (a) or the residue of the polymeric material obtained in (b) or (b.2) with a solvent system having a temperature T2, obtaining a solvent system, which is enriched in dissolved polyalkylene terephthalate based polymer and optionally in additive, and a residue comprising at least one insoluble polymer;
(c.1.2) optionally separating the solvent system, which is enriched in dissolved polyalkylene terephthalate based polymer and optionally in additive, from the residue, thereby obtaining an insoluble polymer-free solvent system enriched in dissolved polyalkylene terephthalate based polymer and optionally in additive, and a residue comprising at least one insoluble polymer; and
(c.2) cooling the solvent system obtained in (c.1), which is enriched in dissolved polyalkylene terephthalate based polymer compared to the solvent provided in (a) and which optionally comprises additive, to a temperature below T2, thereby obtaining a precipitated polyalkylene terephthalate based polymer and a solvent system, which is depleted in dissolved polyalkylene terephthalate based polymer and which optionally comprises additive.

10. (canceled)

11. (canceled)

12. A method for preparing a product comprising:
(I) providing a polyalkylene terephthalate based polymer obtained from the method of claim 1; and
(II) preparing a textile, a fiber, a packaging, a plastic, an automotive part, or an electronic part from the polyalkylene terephthalate based polymer provided in (I).

13. The method according to claim 1, comprising the further step:
converting the re-obtained polyalkylene terephthalate based polymer obtained by the method to obtain a polymer product.

14. The method according to claim 1, comprising the further step:
converting a residue obtained by the method for removal of additives from a polymeric material, and/or
converting the elastic fiber residue obtained by the method for removal of additives from a polymeric material;
to obtain one or more monomer, polymer or polymer product.

15. The method according to claim 14,
wherein the content of the at least one insoluble polymer and/or of the elastic fiber in the polymer and/or polymer product is 1 weight-% or more; and/or
wherein the content of the at least one insoluble polymer and/or of the elastic fiber in the polymer and/or polymer product is 100 weight-% or less.

16. The method according to claim 1, wherein the one or more solvent(s) of the first solvent system and/or second solvent system is/are selected from the group consisting of gamma valerolactone (GVL), N-butylpyrrolidone (NBP), propylenecarbonate, acetophenone dimethyl sulfoxide (DMSO), dihydrolevoglucosenon (Cyrene) and mixtures of two or more thereof.

17. The method according to claim 1, wherein (b.2) comprises:
(b.2.1) separating the solvent system, which is enriched in dissolved additive and the residue of the polymeric material obtained in (b.1), by a physical separation method, thereby obtaining a separated solvent system, which is enriched in dissolved additive and enriched in dissolved elastic fiber compared to the solvent system provided in (a) and the residue of the polymeric material, which is depleted of said additive and said elastic fiber and comprises the polyalkylene terephthalate based polymer; and
(b.2.2) separating the elastic fiber from the solvent system.

18. The method according to claim 12, wherein in (II):
a part of a car selected from the group consisting of a cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, and coating;
a cloth selected from the group consisting of shirt, trousers, pullover, boot, shoe, shoe sole, tight and jacket;
an electrical part selected from the group consisting of electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), and spring tongue;
a consumer, agricultural product or pharmaceutical product selected from the group consisting of tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, and pesticide;
a packaging for the food industry selected from the group consisting of mono- or multi-layer blown film, cast film (mono- or multi-layer), biaxially stretched film, and laminating film; or
a part of a construction selected from the group consisting of a rotor blade, insulating material, frame, housing, wall, coating, and separating wall,
is prepared.

19. The method according to claim 1, further comprising:
converting a residue obtained from step (c.1.2), and/or
converting the elastic fiber residue obtained from step (b.2.2);
to obtain one or more monomer, polymer or polymer product;
wherein the monomer is a di- or polyol; and/or
wherein the polymer is and/or the polymer product; and/or
wherein the polymer and/or the polymer product is/are or is/are a part of:
a part of a car selected from the group consisting of cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, cover for car A, B, C or D pillar, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, and coating;
a cloth selected from the group consisting of shirt, trousers, pullover, boot, shoe, shoe sole, tight and jacket;
an electrical part selected from the group consisting of electrical or electronic passive or active component, circuit board, printed circuit board, housing component, foil, line, switch, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), and spring tongue;
a consumer, agricultural product or pharmaceutical product selected from the group consisting of tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, and pesticide;
a packaging for the food industry selected from the group consisting of mono- or multi-layer blown film, cast film (mono- or multi-layer), biaxially stretched film, and laminating film; or
a part of a construction selected from the group consisting of a rotor blade, insulating material, frame, housing, wall, coating, and separating wall.

20. The method according to claim 14,
wherein the content of the at least one insoluble polymer and/or of the elastic fiber in the polymer and/or polymer product is 2 weight-% or more; and/or
wherein the content of the at least one insoluble polymer and/or of the elastic fiber in the polymer and/or polymer product is 95 weight-% or less; and
wherein the content is determined based on identity preservation and/or segregation and/or mass balance and/or book and claim chain of custody models.
